(19) United States
(12) Patent Application Publication
(10) Pub. No.: US 2024/0320511 A1
(43) Pub. Date: Sep. 26, 2024

(54) INTERFACING WITH CODED INFERENCE NETWORKS

(71) Applicant: Huawei Technologies Co., Ltd., Shenzhen (CN)

(72) Inventors: Yiqun Ge, Ottawa (CA); Wuxian Shi, Ottawa (CA); Wen Tong, Ottawa (CA)

(21) Appl. No.: 18/651,215

(22) Filed: Apr. 30, 2024

Related U.S. Application Data
(63) Continuation of application No. PCT/CN2021/127892, filed on Nov. 1, 2021.

(51) Int. Cl. G06N 3/098

(52) U.S. Cl. CPC G06N 3/098

(57) ABSTRACT

Some embodiments of the present disclosure relate to inferencing using a trained deep neural network. Inferencing may, reasonably, be expected to be a mainstream application of 6G wireless networks. Agile, robust and accurate inferencing is important for the success of AI applications. Aspects of the present application relate to introducing coding theory into inferencing in a distributed manner. It may be shown that redundant wireless bandwidths and edge units help to ensure agility, robustness and accuracy in coded inferencing networks.

### CROSS-REFERENCE TO RELATED APPLICATIONS

This application is a continuation of International Application No. PCT/CN2021/127892, filed on Nov. 1, 2021, the disclosure of which is hereby incorporated by reference in its entirety.

### TECHNICAL FIELD

The present disclosure relates, generally, to coded inference networks and, in particular embodiments, to interfacing with coded inference networks.

### BACKGROUND

Artificial Intelligence (AI) is often referenced as deep learning and may be implemented by a deep neural network (DNN). Recent developments in AI have encourage various industries to start to employ AI to provide benefits, such as improved productivity, improved security and improved stability. These benefits may be understood to be derived from an efficiency that may be realized by sharing a well-trained DNN among many users. Although an initial learning cycle of a DNN may be considered to be costly, data-hungry and tedious, a later inferencing cycle of the DNN can be accessible enough to optimize efficiency and profitability. It follows that a typical scenario in which a DNN is employed involves a trained DNN that is maintained in a centralized data center and remotely accessed by users of the trained DNN.

It may be considered to be expensive, in many aspects, to come up with a DNN that has an inference accuracy high enough to be considered comparable to the inference accuracy of an average human. To achieve such a high inference accuracy, a DNN implementer may be expected to fit a given DNN into a well-designed architecture, feed the given DNN high-fidelity data sets and train the given DNN over nearly infinite computation capability.

The size of a DNN may be measured on the basis of a quantity of neurons and a quantity of layers. Furthermore, the size of a DNN may be considered to be representative of “memorization” and “generalization” capabilities of the DNN. A commercially capable DNN may be considered to demand significant quantities of computation resources and storage resources.

The expense (with respect to time, data and computation) of the initial learning cycle results into a once-for-all DNN concept, see Han Cai, et al. “Once-for-All: Train One Network and Specialize it for Efficient Deployment,” International Conference on Learning Representations (ICLR) 2020. In the once-for-all DNN concept, it is understood that it is more economical to completely train a DNN once for a multitude of tasks. Subsequently, the inference cycle is employed for as long as possible. To prepare the DNN to handle a new task (or new data set), the once-for-all DNN concept advocates only updating a small part of the DNN.

OpenAI is an AI research and deployment company. OpenAI has developed a Generative Pre-trained Transformer (GPT) series of autoregressive language models that use deep learning to produce human-like text. The most recent addition to the series is a third-generation model, called “GPT-3.” The GPT series may be seen as a concept-proof for the once-for-all DNN concept. The GPT-3 model may be shown to be able to handle natural languages, texts, images and videos, at an average-human proficiency level. It is anticipated that an increase in the size of the DNN will further enhance the inferencing accuracy and to widen the scope of the supported tasks.

The GPT-3 model may be considered to be a giant DNN in size. The GPT-3 model contains billions of neurons and the available dimensions for input and output are in the thousands. It reportedly took OpenAI three months to train the GPT-3 model. It is said that the energy consumed by 100-time trainings over the GPT-3 model is equivalent to the annual energy consumed by a 150,000-population city. The GPT-3 model appears to have triggered an “arms race” for higher inferencing accuracy by DNNs. Soon after Google announced a ten-billion-neuron DNN, OpenAI announced a plan to triple the size of the GPT-3 model.

An immediate result of this so-called arms race is that the inferencing accuracy that is provided by a data center becomes much higher than the inferencing accuracy that any terminal user equipment could provide. In a winner-take-all commercial market, it is reasonable for a terminal user to abandon a local DNN strategy and switch to a remote-access-to-a-centralized-DNN strategy for AI reference tasks or jobs. Responsive to more users choose this strategy, the centralized DNN may become vulnerable to a scenario wherein an inferencing reliability of the centralized DNN, rather than the inference accuracy of the centralized DNN, dominates an average user experience. If an inference request or an inference result is lost or severely delayed over a poor communication channel, the inference task may be regarded as having failed, even though the centralized DNN is actually doing an excellent inferencing job. When the communication channel between the user and the centralized DNN is in a wireless connection, typical radio hostilities (packet loss, delay, jitter and noise) may be shown to increase the odds of regarding a given inference task as having failed.

### SUMMARY

Aspects of the present application relate to inferencing using a trained DNN. Inferencing may, reasonably, be expected to be a mainstream application of sixth generation (6G) wireless networks. Agile, robust and accurate inferencing is important for the success of AI applications. Aspects of the present application relate to introducing coding theory into inferencing in a distributed manner. It may be shown that redundant wireless bandwidths and edge units help to ensure agility, robustness and accuracy in coded inferencing networks.

Obtaining a DNN inference is a non-linear computation. The non-linearity of obtaining a DNN inference may be considered to be a major obstacle to achieving success by applying, to DNN inference, an idea similar to coded computation.

According to aspects of the present application, a reverse-learning-based method is used to train a plurality of redundant inference units. Together with a plurality of systematic inference units, a plurality of redundant inference units, which implement redundant inference functions, may be seen to form a coded inference network representative of a pre-existing DNN. In this way, a coding gain becomes feasible for a DNN inference, which, as has been discussed hereinbefore, is a non-linear computation. Consequently, inference reliability for the pre-existing and trained DNN may be secured by the coding gain.

According to an aspect of the present disclosure, there is provided a method of managing a plurality of inference requests destined for a coded inference network representative of a deep neural network (DNN), the coded inference network including a first coded inference stage and a last coded inference stage, the first coded inference stage implementing a first non-linear function representative of a first sub-DNN of the DNN, the last coded inference stage implementing a further non-linear function representative of a further sub-DNN of the DNN. The method includes receiving, from a particular source, a particular inference request, encoding the plurality of inference requests, including the particular inference request, to, thereby, form a plurality of coded inference requests, the encoding being specific to first coded inference stage, transmitting, to the first coded inference stage, the inference requests and the coded inference requests, receiving, from the last coded inference stage, a plurality of inference results and a plurality of redundant inference results, decoding the plurality of inference results and the plurality of estimated inference results to form a plurality of estimated inference results, the decoding specific to the last coded inference stage, selecting either the plurality of inference results or the plurality of estimated inference results as a plurality of selected inference results, thereby generating a plurality of selected inference results, and transmitting, to the particular source, a particular inference result corresponding to the particular inference request, the particular inference result selected from among the plurality of selected inference results.

According to an aspect of the present disclosure, there is provided an apparatus. The apparatus includes a memory storing instructions and a processor caused, by executing the instructions, to manage a plurality of inference requests destined for a coded inference network representative of a deep neural network (DNN), the coded inference network including a first coded inference stage and a last coded inference stage, the first coded inference stage implementing a first non-linear function representative of a first sub-DNN of the DNN, the last coded inference stage implementing a further non-linear function representative of a further sub-DNN of the DNN. The processor manages the plurality of inference requests by receiving, from a particular source, a particular inference request, encoding the plurality of inference requests, including the particular inference request, to, thereby, form a plurality of coded inference requests, the encoding specific to the first coded inference stage, transmitting, to the first coded inference stage, the inference requests and the coded inference requests, receiving, from the last coded inference stage, a plurality of inference results and a plurality of redundant inference results, decoding the plurality of inference results and the plurality of estimated inference results to form a plurality of estimated inference results, the decoding specific to the last coded inference stage, selecting either the plurality of inference results or the plurality of estimated inference results as a plurality of selected inference results, thereby generating a plurality of selected inference results, and transmitting, to the particular source, a particular inference result corresponding to the particular inference request, the particular inference result selected from among the plurality of selected inference results.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates a generic remote access inference system;

FIG. 6 illustrates an altered remote access inference system implementing a coding scheme;

FIG. 7 illustrates a system that implements a more complicated coding scheme relative to the coding scheme implemented by the altered remote access inference system of FIG. 6;

FIG. 8 illustrates a system that includes many of the elements of the system of FIG. 7, a focus of FIG. 8 is on the inferencing requesting user receiving inference results from the inference units, in accordance with aspects of the present application;

FIG. 9 illustrates a training arrangement for a DNN to be used for a redundant inference unit, in accordance with aspects of the present application;

FIG. 10 illustrates, in a flow diagram, example steps in a training method, in accordance with aspects of the present application;

FIG. 11 illustrates a trained giant deep neural network;

FIG. 12 illustrates a divided trained giant DNN based on dividing the trained giant DNN of FIG. 11 into a plurality, L, of partitions, in accordance with aspects of the present application;

FIG. 13 illustrates example components of a first coded inference stage including a first linear encoder, multiple inference units and a second dispatcher, in accordance with aspects of the present application;

FIG. 14 illustrates example components of the second dispatcher, in accordance with aspects of the present application;

FIG. 15 illustrates example components of an ender, similar to the second dispatcher of FIG. 14, but lacking an encoder, in accordance with aspects of the present application;

FIG. 16 illustrates a coded inference network that brings together the components discussed in view of FIGS. 12, 13, 14 and 15, in accordance with aspects of the present application;

FIG. 17 illustrates a transmit and receive point (TRP) interfacing with a coded inference network, in accordance with aspects of the present application;

FIG. 18 illustrates example steps in a method, for carrying out at the TRP, of interfacing with the coded inference network of FIG. 17, in accordance with aspects of the present application;

FIG. 19 illustrates the coded inference network of FIG. 17 serving more than one TRP, in accordance with aspects of the present application;

FIG. 20 illustrates two distinct sets of electronic devices whose inference requests may be aggregated at a TRP, in accordance with aspects of the present application;

FIG. 21 illustrates an inference scheduler for managing a collection of coded inference stages and dispatchers in respect of inference requests received from the TRP of FIG. 20, in accordance with aspects of the present application;

FIG. 22 illustrates an example distribution of (radio) beams among two dispatchers and a plurality of inference units, in accordance with aspects of the present application; and

FIG. 23 illustrates the trained giant deep neural network from FIG. 11 and the coded inference network from FIG. 16.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

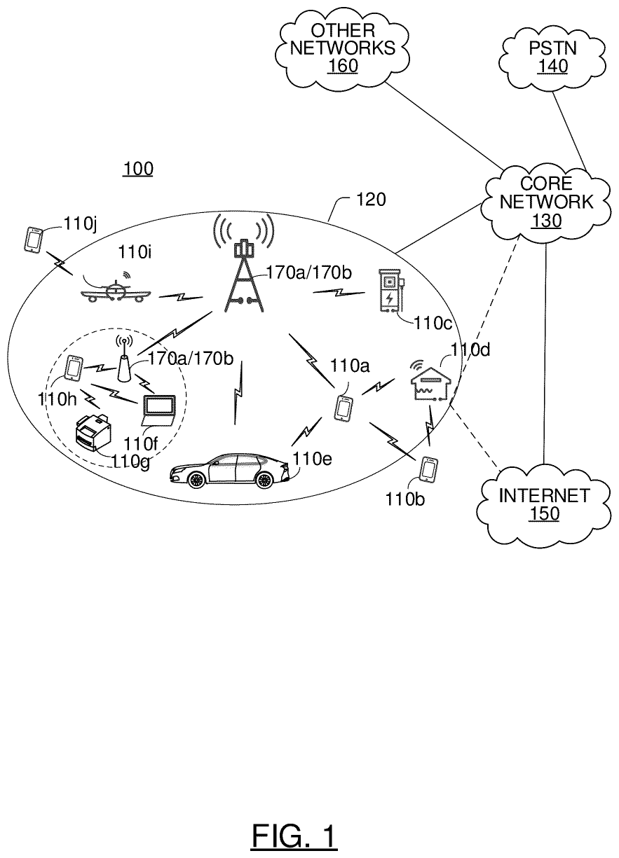

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

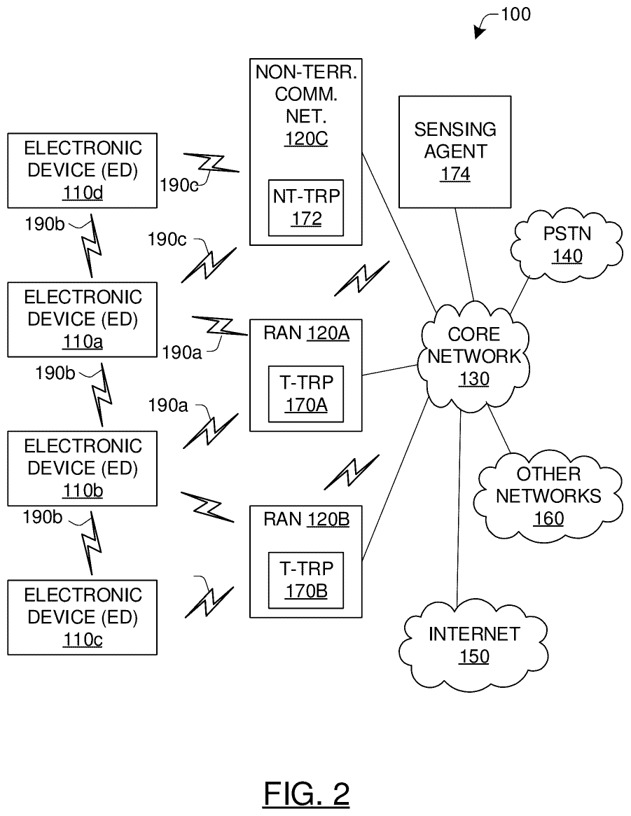

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, the core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over an non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

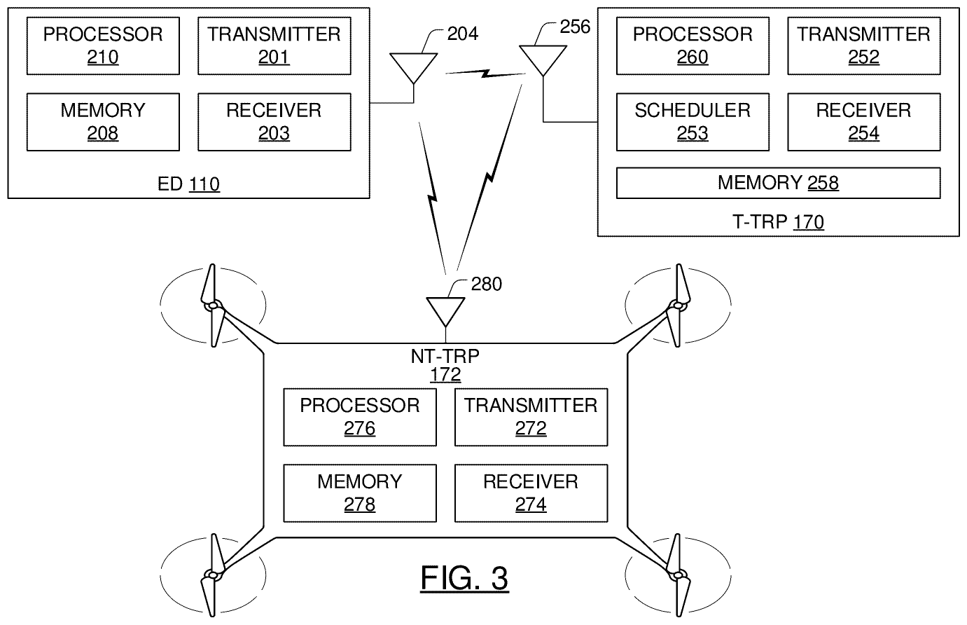

FIG. 3 illustrates another example of an ED 110 and a TRP 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

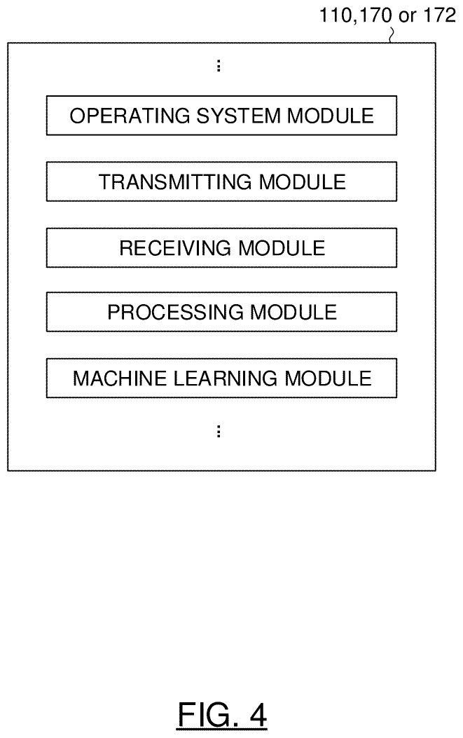

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot has a 0.5 ms duration. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a TRP 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a TRP 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

The carrier, the BWP or the occupied bandwidth may be signaled by a network device (e.g., by a TRP 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

Going to the future wireless network, the number of the new devices could be increased exponentially with diverse functionalities. Also, a lot more new applications and use cases than those associated with 5G may emerge with more diverse quality of service demands. These use cases will result in new key performance indications (KPIs) for the future wireless networks (for one example, a 6G network) that can be extremely challenging. It follows that sensing technologies and AI technologies, especially ML and deep learning technologies, are being introduced to telecommunication for improving the system performance and efficiency.

AI/ML technologies may be applied to communication systems. In particular AI/ML technologies may be applied to communication in Physical layer and to communication in media access control (MAC) layer.

For the physical layer, the AI/ML technologies may be employed to optimize component design and improve algorithm performance. For example, AI/ML technologies may be applied to channel coding, channel modelling, channel estimation, channel decoding, modulation, demodulation, MIMO, waveform, multiple access, PHY element parameter optimization and update, beam forming and tracking and sensing and positioning, etc.

For the MAC layer, AI/ML technologies may be utilized in the context of learning, predicting and making decisions to solve complicated optimization problems with better strategy and optimal solution. For one example, AI/ML technologies may be utilized to optimize the functionality in MAC for, e.g., intelligent TRP management, intelligent beam management, intelligent channel resource allocation, intelligent power control, intelligent spectrum utilization, intelligent modulation and coding scheme selection, intelligent HARQ strategy, intelligent transmit/receive mode adaption, etc.

AI/ML architectures usually involve multiple nodes. The multiple nodes can be organized in two modes, i.e., a centralized mode and a distributed mode, both of which modes can be deployed in an access network, a core network or an edge computing system or third network. A centralized training and computing architecture is restricted by communication overhead and strict user data privacy. Distributed training and computing architecture may be organized according to several frameworks, e.g., distributed machine learning and federated learning. AI/ML architectures include an intelligent controller, which can perform as a single agent or as a multi-agent, based on joint optimization or individual optimization. New protocols and signaling mechanisms may be established so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, tracking, autonomous delivery and mobility. Terrestrial network-based sensing and non-terrestrial network-based sensing could provide intelligent context-aware networks to enhance the UE experience. For an example, terrestrial network-based sensing and non-terrestrial network-based sensing may be shown to provide opportunities for localization applications and sensing applications based on new sets of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial networks and in non-terrestrial networks, the measured channel data and sensing and positioning data can be obtained by large bandwidth, new spectrum, dense network and more light-of-sight (LOS) links. Based on these data, a radio environmental map can be drawn through AI/ML methods, where channel information is linked, in the map, to its corresponding positioning, or environmental information, to, thereby, provide an enhanced physical layer design based on this map.

Sensing coordinators are nodes in a network that can assist in the sensing operation. These nodes can be stand-alone nodes dedicated to just sensing operations or other nodes (for example, the T-TRP 170, the ED 110, or a node in the core network 130) doing the sensing operations in parallel with communication transmissions. New protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored and exchanged. The characteristics of wireless data are known to expand to large ranges in multiple dimensions, e.g., from sub-6 GHz, millimeter to Terahertz carrier frequency, from space, outdoor to indoor scenario, and from text, voice to video. These data are collecting, processing and usage are performed in a unified framework or a different framework.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectrum efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectrum efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

AI may be considered among the most interesting and important application for use with 6G networks. AI is commonly realized using a DNN. Industries adopt AI to improve productivities. For a human-level inferencing accuracy, great efforts have been made to train a DNN using a stochastic gradient descendent (SGD) algorithm. Training a DNN is typically performed in relation to a specific task and makes use of a specific training data set.

When it comes to training a given DNN for a new task or using new training data set, training the given DNN from scratch is known to be costly and, accordingly, training from scratch is generally avoided. This notion has triggered research into giant once-for-all DNNs, see Han Cai, et al. “Once-for-All: Train One Network and Specialize it for Efficient Deployment,” ICLR 2020. Rather than training a dedicated DNN specifically for one task, a once-for-all DNN is trained for a multitude of tasks. Training a once-for-all DNN for a new task is known to involve updating a relatively small part of the neurons in the once-for-all DNN so that the once-for-all DNN may handle the new task. This approach is based on an assumption that the new task has a certain amount of similarity with old tasks for which the once-for-all DNN has already been trained. In general, a once-for-all DNN is expected to have a great number of neurons to memorize and generalize a wide scope of tasks.

GPT-3 by OpenAI, see Brown, Tom, et al. “Language Models are Few-Shot Learners,” Part of Advances in Neural Information Processing Systems 33 (NeurIPS 2020), is a concept-proof of once-for-all DNN. The once-for-all DNN, GPT-3, translates natural languages, generates texts, classifies images, generates images, classifies videos, generates videos, and the like. GPT-3 is a giant DNN in all aspects. GPT-3 contains billions of neurons and thousand-dimensional input and output. OpenAI spent three months training it over a data center with more than 100,000 GPUs.

More companies have joined into the race for better DNNs by investing heavily into GPU data centers. In an optimistic view, the size of a DNN may progress to a point at which the inferencing accuracy is high enough to handle tasks such as editing, writing, speaking, surveying, collecting, organizing, classifying, etc. In the near future, it may be expected that everyday software or applications on user equipment may be reduced to an AI interface that handles remote-access outsourcing, to a giant DNN via a network connection, for an inferencing job rather than executing the inferencing job using local computing resources. Such remote-access outsourcing may be shown to cut costs on the terminal user equipment side. Furthermore, such remote-access outsourcing may be shown to be particularly useful for IoT equipment.

It is expected that such a giant DNN will be implemented at a GPU data center with millions of GPUs and CPUs. It is known that a GPU data center both consumes energy and produces heat. Accordingly, it is known to establish in a GPU data center in a location where the weather is, generally, cold and the energy is relatively inexpensive. Often, such a location is geographically distant from terminal users. The geographic distance may be shown to make an unreliable communication channel between the GPU data center and the end-user a primary problem.

An entity implementing a GPU data center concerns itself with: how to efficiently fit a giant DNN into well-designed architecture; how to feed the giant DNN with some high-fidelity training data sets; and how to stably train the giant DNN over a large number of GPUs. In contrast, a terminal user concerns itself with how to agilely, accurately and robustly complete a remote inferencing job. From the point of view of the terminal user, an unreliable communication channel between the GPU data center and the terminal user would completely destroy the experience of the terminal user and the terminal user's perceived performance of the giant DNN.

Entities implementing giant DNNs are expected to continue to improve the giant DNNs. However, the communication channel between the GPU data center and the terminal user is, generally, outside of the scope of control of such entities.

Currently, an inferencing request job (including inputs and parameters) is transmitted, in a normal data packet, through a wireless access network and a core network toward a giant DNN. Both access transmission, through the wireless access network, and thousand-mile fiber transmission, through the core network, may be shown to introduce delay, noise, distortion, packet loss and jitter. It may be shown that a relatively large number of inferencing request jobs simultaneously transmitted toward a single giant DNN would cause a traffic jam in the communication channel and long buffer queues. Even though the single giant DNN may be well trained and maintained in a data center, hostile communication channels may be shown to severely degrade an overall inferencing reliability that most terminal users would experience. Last, but not least, a system that includes a large number of terminal users that completely rely on a single giant DNN at a remote data center, may be unable to tolerate a malicious attack or an incautious accident.

One mitigation strategy may involve decentralizing a single giant DNN trained at a data center. Indeed, the strategy may involve migrating the decentralized DNN to a plurality of edge inference units close to terminal users. However, such a mitigation strategy should carefully address packet loss, delays, jitter and noise over wireless access communication channels, especially in the presence of increasing numbers of competitive terminal users. Notably, when decentralizing the single giant DNN involves distributing the single giant DNN into a network of edge inference units (edge computing nodes), a single edge inference unit may be unable to accommodate the single giant DNN having billions of neurons.

In overview, aspects of the present application relate to coded inference networks that receive inference requests and produce inference responses. Additionally, aspects of the present application relate to interfacing with such coded inference networks.

Since the coded inference network is inspired by coded computation and coded networks, coded computation and coded networks are introduced first, before starting to discuss the coded inference network. Since a coded network is a special case of coded computation, the initial focus is on coded computation.

The goal of coded computation is to enhance computation reliability by accessing redundant computation units. The redundant computation units and systematic computation units combine in a linear code that yields a coding gain, according to coding theory. For example, a user has a linear computation job X for an edge computation unit “A” that implements a function, ƒ(·). The user sends X to the edge computation unit A. The edge computation unit A determines Y=ƒ(X) and sends Y back to the user.

It may be recognized that there are times wherein a link between the user and the edge computation unit A (either the forward link or the backward link or both links) may become unreliable (packet loss or severely delay).

To mitigate the unreliability, a known solution is to add another edge computation unit “B” that implements the same function, ƒ(·). Accordingly, responsive to the user sending X to the edge computation unit B, the edge computation unit B determines Y=ƒ(X) and sends Y back to the user. Employing such a solution, the user sends X to both the edge computation unit A and the edge computation unit B. If the user successfully receives Y from either edge computation unit, the user may consider that the computation is complete.

There is a first failure probability that the user does not receive Y from the edge computation unit A. There is a separate and distinct second failure probability that the user does not receive Y from the edge computation unit B. There is a third failure probability that the user does not receive Y from the edge computation unit A or from the edge computation unit B.

The third failure probability is lower than the first failure probability and the second probability. The reduction of the failure probability from the first failure probability to the lower third probability is representative of a “coding gain.” This simple, double-unit example may be referenced as a repetitive linear code.

A repetitive code is the simplest channel code. When there exists more than one computation job to be solved, more coding gain could be sought.

Consider a scenario wherein the user has two exact linear computation jobs that involve providing input X₁ and input X₂ and expecting output Y₁=ƒ(X₁) and output Y₂=ƒ(X₂). Consider, also, that there are three edge computation units: edge computation unit A; edge computation unit B; and edge computation unit C. At a given time, the user sends X₁ to the edge computation unit A, which determines Y₁=ƒ(X₁). At the same given time, the user sends X₂ to edge computation unit B, which determines Y₂=ƒ(X₂). At the same given time, the user sends X₁+X₂ to edge computation unit C, which determines Y′=ƒ(X₁+X₂).

Suppose that the erasure rate for each edge computation unit is ⅓. That is, it is likely that the user will receive only two of Y₁, Y₂, and Y′ per time. In one possibility, the user receives Y₁ and Y₂, which is desired. If the user receives Y₁ and Y′, then it can be expected that the user can obtain Y₂ through the use of a decoding equation, Y₂=Y′−Y₁. If the user receives Y₂ and Y′, then it can be expected that the user can obtain Y₁ through the use of a decoding equation, Y₁=Y′−Y₂. In coding theory terminology, the edge computation unit A and the edge computation unit B are systematic computation units; whereas the edge computation unit C is a redundant computation unit. For consistency, the discussion following hereinafter uses the terms “systematic” and “redundant” for various computation units.

According to coding theory, the coding gain (reduction of the failure probability) can be improved either when more computation jobs are encoded together or when the ratio between the number of jobs and the number of edge computation units is reduced. Following the example hereinbefore, the user may take an approach that involves encoding 20 jobs for 30 edge computation units, thereby reducing the failure probability. The user may take an approach that involves encoding two jobs for six edge computation units, thereby reducing the failure probability. The former approach involves increasing the code length. The latter involves lowering the coding rate.

In theory, a coded network scheme is a special coded computation with ƒ(·): Y=X.

To be clear, coded computation only works reliably with linear computation. Obtaining a DNN inference is a non-linear computation. The non-linearity of obtaining a DNN inference may be considered to be a major obstacle to achieving success by applying, to DNN inference, an idea similar to coded computation.

According to aspects of the present application, a reverse-learning-based method is used to train a plurality of redundant inference units. Together with a plurality of systematic inference units, a plurality of redundant inference units, which implement redundant inference functions, may be seen to form a coded inference network representative of a pre-existing DNN. In this way, a coding gain becomes feasible for a DNN inference, which, as has been discussed hereinbefore, is a non-linear computation. Consequently, inference reliability for the pre-existing DNN may be secured by the coding gain.

The feasibility of a coded inference allows for division of a giant DNN into a cascade of sub-DNNs, where each sub-DNN may be implemented in a coded inference stage. Between two consecutive coded inference stages, there may be placed a dispatcher that decodes the intermediate inference results from a preceding stage, encodes the intermediate inferenced results and then sends the intermediate inferenced results to a subsequent coded inference stage. A cascade of coded inference stages and intermediate dispatchers form a coded inference network.

A coded inference network can be deployed within the wireless access network and the core network of a 6G network. In operation, a TRP 170 collects inference request jobs from multiple users. The TRP 170 may be seen to act as the first dispatcher for the ensuing coded inference network. The inference request jobs propagate from a first coded inference stage to a last coded inference stage in a cascaded manner. Inference results propagate from the last coded inference stage back to the first coded inference stage. The inference results then reaches the TRP 170. The TRP 170 sends a respective inference result to each user.

Inference over a DNN may be regarded as “forward-only.” Accordingly, computation and data precision related to implementing a coded inference network for a DNN are significantly reduced relative to computation and data precision related to training a DNN. It follows that a coded inference network can be implemented using much simpler hardware circuits than the hardware circuits associated with training a DNN.

As the coded inference network forms a systematic linear code (even though the inference functions that the coded inference network supports are non-linear), both encoder and decoder are linear. It follows that the encoder and decoder may be implemented using beamforming. In particular, the “addition” and “subtraction” may be realized using spacious juxtaposition in beamforming. Ideally, the forward DNN can be implemented in an analogous domain.

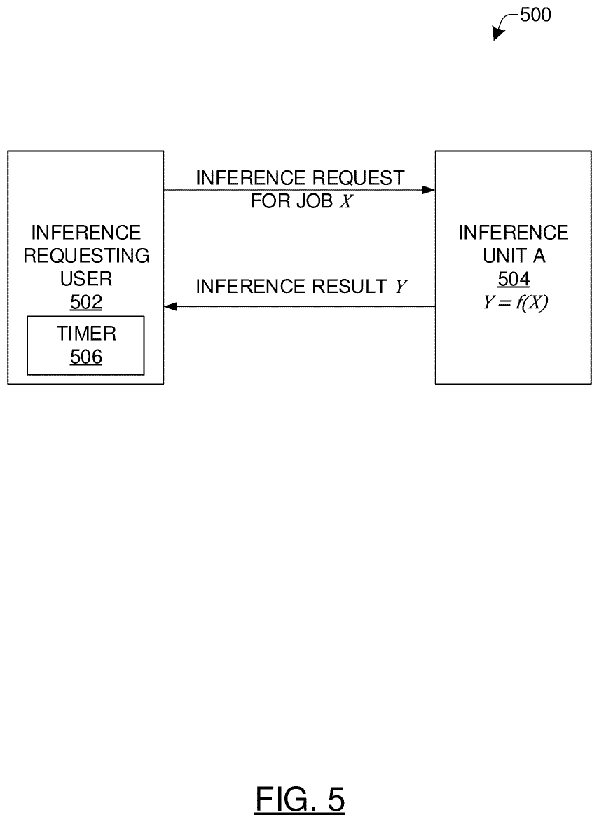

FIG. 5 illustrates a generic remote access inference system 500. An inference over a trained DNN may be denoted as a non-linear function: ƒ(·). Consider, in view of FIG. 5, that an inference requesting user 502 wishes to execute an inference request job, X, over ƒ(·). The inference requesting user 502 sends the inference request job X to an inference unit A 504. Responsive to receiving the inference request, the inference unit A 504 physically conducts an inference to determine an inferenced result, Y=ƒ(X), using a computation resource associated with the inference unit A 504. The inference involve some non-linear computation. The inference unit A 504 then sends the inference result, Y, to the inference requesting user 502. Suppose that there exists, at the inference requesting user 502, an inference job timer 506. Example applications that may transmit timer-related inference requests including drones and driverless cars. The inference requesting user 502 may initialize the inference job timer 506 in conjunction with sending the inference request for inference request job X to the inference unit A 504. The inference job timer 506 may commence counting down. If the inference requesting user 502 fails to receive Y before the inference job timer 506 runs down to zero, the inference request for inference request job X may be considered to have ended in failure. The failure may be due to a computation traffic keeping the inference unit A 504 busy. The failure may be due to a poor communication channel between the inference requesting user 502 and the inference unit A 504.

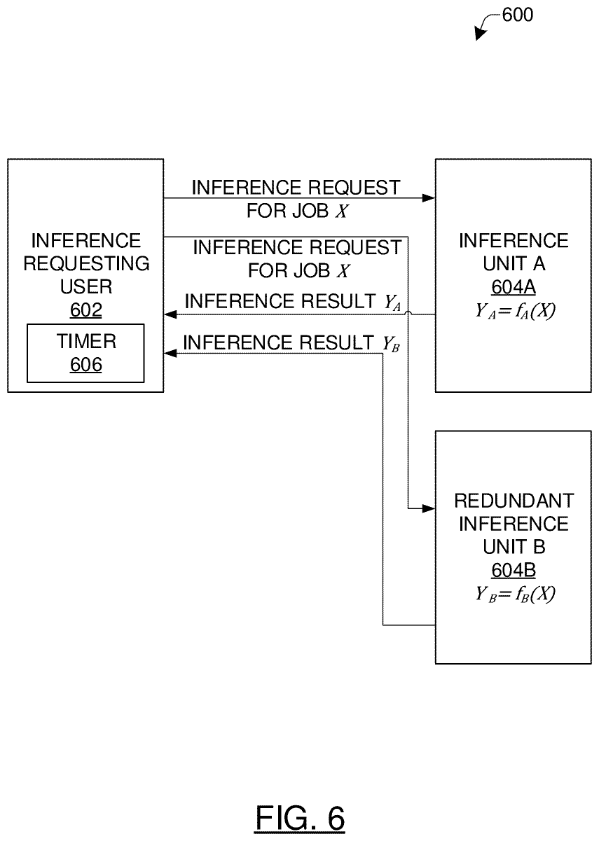

FIG. 6 illustrates an altered remote access inference system 600. In a manner similar to the remote access inference system 500, the altered remote access inference system 600 includes an inference requesting user 602 and an inference unit A 604A. The altered remote access inference system 600 of FIG. 6 differs from the remote access inference system 500 of FIG. 5 in that the altered remote access inference system 600 of FIG. 6 includes a redundant inference unit B 604B. The redundant inference unit B 604B physically carries out the exact same inference operation, Y_{B}=ƒ(X), as the inference operation, Y_{A}=ƒ(X) carried out at the inference unit A 604A. Accordingly, the inference requesting user 602 may send the inference request for inference request job X both to the inference unit A 604A and to the redundant inference unit B 604B simultaneously (thereby, consuming double radio bandwidth).

Suppose that there exists, at the inference requesting user 602, an inference job timer 606. The inference requesting user 602 may initialize the inference job timer 606 in conjunction with sending the inference request job X to the inference unit A 604A and to the inference unit B 604B. The inference job timer 606 may commence counting down. If the inference requesting user 602 fails to receive Y_{A} before the inference job timer 606 runs down to zero and the inference requesting user 602 fails to receive Y_{B} before the inference job timer 606 runs down to zero, the inference request job X may be considered to have ended in failure. However, if the inference requesting user 602 receives either Y_{A} or Y_{B} or both Y_{A} and Y_{B} before the inference job timer 606 runs down to zero, the inference request job X may be considered to have ended in success.

Notably, the addition of the inference unit B 604B provides a reduction in a probability of the inference request job X being considered to have ended in failure. The reduction can be explained by channel coding theory. The altered remote access inference system 600 implements a repetitive code with a ½ coding rate that, accordingly, yields a coding gain. According to coding theory, an addition of further redundant inference units, with a corresponding increase in use of radio bandwidth, may be expected to further reduce a probability of the inference request job X being considered to have ended in failure.

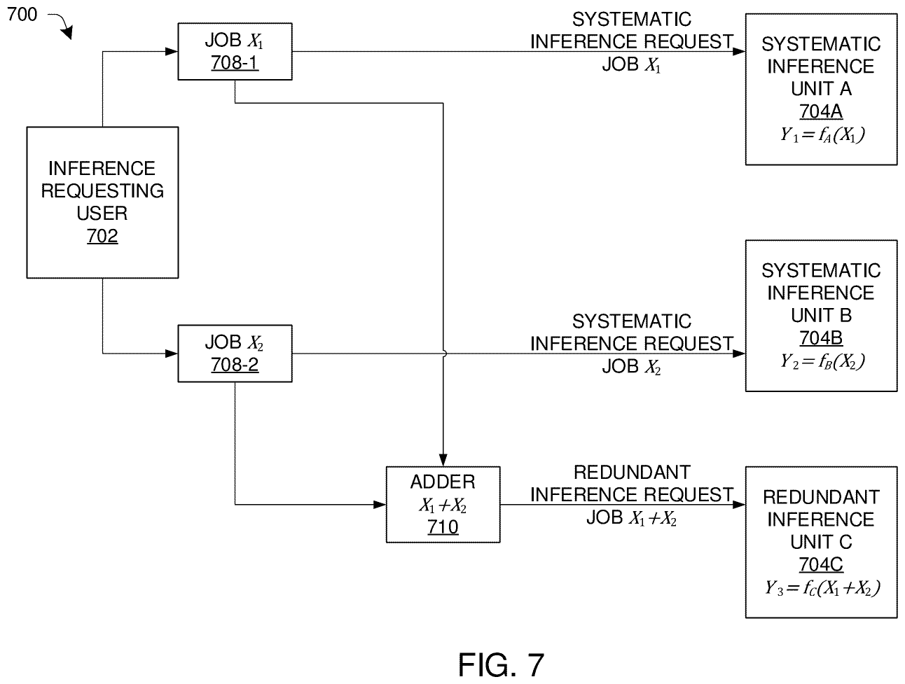

A repetitive coding scheme may be considered to be the most naïve coding scheme. For a higher coding gain, a more complicated coding scheme may be adopted. FIG. 7 illustrates a system 700 that implements a more complicated coding scheme relative to the coding scheme implemented by the altered remote access inference system 600 of FIG. 6. An inferencing requesting user 702 wishes to execute two inference request jobs, X₁ and X₂, over ƒ(·). The inference request jobs are illustrated in FIG. 7 as a first inference request job X₁ 708-1 and a second inference request job X₂ 708-2. The system 700 of FIG. 7 includes three inference units: a systematic inference unit A 704A; a systematic inference unit B 704B; and a redundant inference unit C 704C.

In operation, the inferencing requesting user 702 sends the first systematic inference request job X₁ 708-1 to the systematic inference unit A 704A. The inferencing requesting user 702 also sends the second systematic inference request job X₂ 708-2 to the systematic inference unit B 704B. The inferencing requesting user 702 may also arrange that an adder 710 form a sum of the first inference request job X₁ 708-1 and the second inference request job X₂ 708-2. The sum may be referenced as a redundant inference request job X₁+X₂. The inferencing requesting user 702 may then arrange the sending of the redundant inference request job X₁+X₂ to the redundant inference unit C 704C.

Both the systematic inference unit A 704A and the systematic inference unit B 704B are configured to carry out the same DNN inference, that is,

$${f}_{A} ( \cdot ) = {f}_{B} ( \cdot ) = f ( \cdot ) .$$

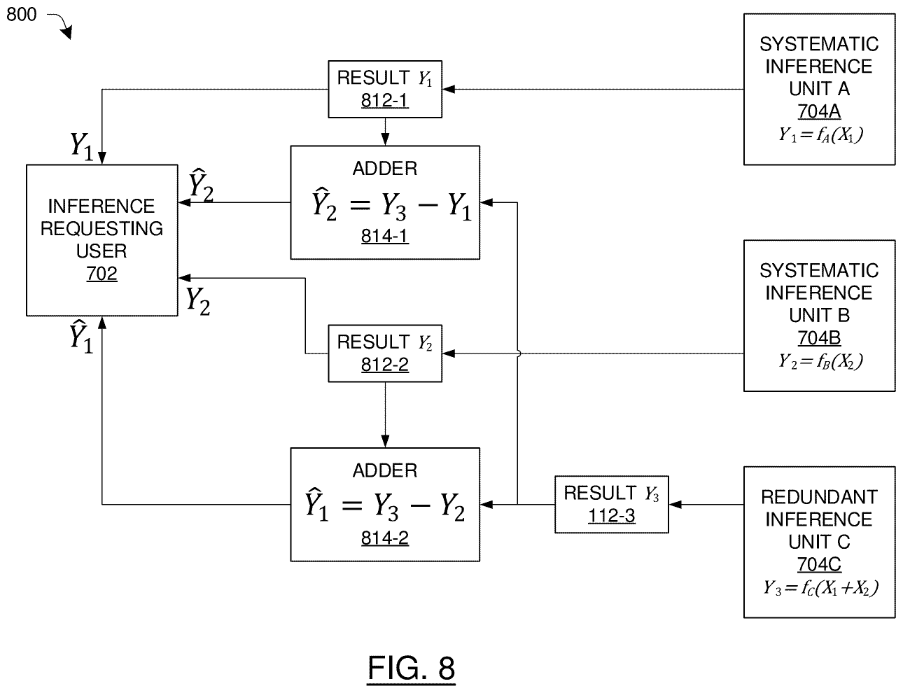

FIG. 8 illustrates a system 800 that includes many of the elements of the system 700 of FIG. 7. While a focus of FIG. 7 is on the inferencing requesting user 702 sending inference requests to the inference units 704A, 704B, 704C, a focus of FIG. 8 is on the inferencing requesting user 702 receiving inference results from the inference units 704A, 704B, 704C. In particular, the systematic inference unit A 704A returns inference result Y₁ 812-1, where Y₁=ƒ_{A}(X₁), to the inferencing requesting user 702. The systematic inference unit B 704B returns inference result Y₂ 812-2, where Y₂=ƒ_{B}(X₂), to the inferencing requesting user 702. The redundant inference unit C 704C carries out a different inference to return inference result Y₃ 812-3, where Y₃=ƒ_{C}(X₁+X₂). Notably, ƒ_{C}(·)≠ƒ(·) because ƒ(·) is non-linear in reference. To enable a coding gain, a ƒ_{C}(·) is determined such that ƒ_{C}(·) satisfies a plurality of conditions.

A first condition relates to a scenario wherein the inferencing requesting user 702 receives Y₁ and Y₃. That is, the inference result Y₂ 812-2 is lost. According to the first condition, ƒ_{C}(·) may be determined in a manner that allows a first adder 814-1 to obtain an estimated inference result, Ŷ₂, for the inference result Y₂ 812-2 such that Ŷ₂≈Y₂. More specifically, ƒ_{C}(·) may be determined in a manner that produces, from the redundant inference request job X₁+X₂, the inference result Y₃ 812-3, where Y₃=ƒ_{C}(X₁+X₂), that allows the estimated inference, Ŷ₂, to be obtained by subtracting Y₁ from Y₃. That is, the estimated inference result may be obtained, at the first adder 814-1, from Ŷ₂=Y₃−Y₁.

A second condition relates to a scenario wherein the inferencing requesting user 702 receives Y₂ and Y₃. That is, the inference result Y₁ 812-1 is lost. According to the second condition, ƒ_{C}(·) may be determined in a manner that allows a second adder 814-2 to obtain an estimated inference result, Y₁, for the inference result Y₁ 812-1 such that Ŷ₁≈Y₁. More specifically, ƒ_{C}(·) may be determined in a manner that produces, from the redundant inference request job X₁+X₂, an inference result Y₃ 812-3, where Y₃=ƒ_{C}(X₁+X₂), that allows the estimated inference result, Ŷ₁, to be obtained by subtracting Y₂ from Y₃. That is, the estimated inference result may be obtained, at the second adder 814-2, from Ŷ1=Y₃−Y₂.

Given that an appropriate ƒ_{C}(·) has been determined and installed on the redundant inference unit C 704C, the inferencing requesting user 702 may, upon succeeding in receiving, in time, any two inference results from the three inference units 704, have an inferenced result for inference request job X₁ and an inferenced result for inference request job X₂. This example is a systematic linear code with ⅔ coding rate and code length 2. In review, the systematic inference unit A 704A carries out a systematic inference, the systematic inference unit B 704B carries out a systematic inference, whereas the redundant inference unit C 704C carries out a redundant inference.

According to coding theory, there are several strategies to further improve the coding gain.

Consider a first case in which a user sends 100 inference requests, X₁, X₂, X₃, . . . , and X₁₀₀ to 150 inference units, thereby implementing a systematic linear code with ⅔ coding rate and code length of 100. In this first case, a longer code length may be shown to significantly improve the coding gain.

Consider a second case in which a user sends two inference requests X₁ and X₂ to six inference units, thereby implementing a systematic linear code with a ⅓ coding rate and a code length of two. In this second case, a lower coding rate may be shown to significantly improve the coding gain.

A higher coding gain herein translates into more tolerance to inferencing failure. As discussed hereinbefore, an inferencing failure may either be due to heavy traffic on an inference unit or due to an unstable wireless communication channel. In overview, it may be considered that coding theory allows redundancy in inference and redundancy in communication to buy inference reliability. The inference reliability may be expressed in terms of latency and in terms of accuracy.

In consideration of a generic inference system, there may be a desire to satisfy a particular number, K, of simultaneous inferencing requests. This translates to a system implementing a code with a code length K. The generic inference system may have a number, M, of available inference units, where M>K. This translates to a system implementing a code with a coding rate of K/M. The generic inference system may carry out inferencing with a DNN represented as ƒ(·). The generic inference system may implement a systematic linear encoding function, F(·), and at least one decoding function, G(·). It may be understood that the generic inference system includes (M-K) redundant inference units. Each one of the redundant inference units will implement a redundant inferencing function. One task, when designing the generic inference system, involves determining redundant inferencing functions corresponding to each of the redundant inference units.

The example system 800 of FIG. 8 is designed to handle two simultaneous inferencing requests per fire, that is, K=2 and the code length is 2. Furthermore, there are three inference units. Accordingly, M=3 and the coding rate is

$$\frac{2}{3} . F ( \cdot ) : {X}_{3} = {X}_{1} + {X}_{2}$$

and G(·): Ŷ₂=Y₃−Y₁, Ŷ₁=Y₃−Y₂. One design task involves determining an appropriate ƒ_{C}(·) for the redundant inference unit C 704C, given the DNN ƒ(·).

One approach to determining an appropriate redundant inferencing function ƒ_{C}(·) may involve so-called reversed-learning. The redundant inferencing function may be considered to be a deep neural network, ƒ_{C}(; θ), where θ represents coefficients of the neurons of the deep neural network.

Before conducting reversed-learning, some preparations are carried out. The preparations include preparing a training data set and setting up a training goal.

Preparing a training data set involves obtaining the original data set that was used to train the DNN ƒ(·). The original data set may be obtained in at least two ways. The original training data set (X, Y) for training the DNN ƒ(·) may simply be available. Alternatively, the original training data set may be generated using a regeneration method. In the regeneration method, the given and trained DNN ƒ(·) is used with some select inputs, X, to obtain pairs (x, ƒ(X)). In practice, the regeneration method is more useful because the regeneration method can result in a smaller ƒ_{C}(; θ). For example, consider a huge once-for-all DNN ƒ(·) built for accepting natural language input in any one of multiple different languages. In a use case wherein users are always using English for the natural language input, it may suffice to train ƒ_{C}(; θ) for only the English portion of once-for-all DNN ƒ(·).

Setting up training goals involves designing a linear code. The linear code may include a systematic linear encoding function, F(·), a first linear decoding function, G(·), such that Ŷ₂=G(Y₁, Y₃) and a second linear decoding function, G′(·), such that Ŷ₁=G′(Y₂, Y₃), where Y₁=ƒ_{A}(X₁), Y₂=ƒ_{B} (X₂) and Y₃=ƒ_{C}(X₃; θ). Note that it should be clear that the first linear decoding function, G(·), and the second linear decoding function, G′(·), are differentiable (since all linear operations are differentiable) and the linear decoding functions can be the same or different.

A first training goal relates to handling a scenario in which Y₂ is lost or severely delayed. This first training goal relates to employing knowledge of (X₁, Y₁) and (X₂, Y₂) to configure the neurons, θ, the systematic linear encoding function, F(·), and the first linear decoding function, G(·), so as to minimize

$${f}_{C} ( ; {θ}^{*} ) = arg {min}_{θ} ( {‖ {Y}_{2} - G ( {Y}_{1} , {f}_{C} ( {X}_{3} ; θ ) ) ‖}^{2} ) .$$

A second training goal relates to handling a scenario in which Y₁ lost or severely delayed. This second training goal relates to employing knowledge of (X₁, Y₁) and (X₂, Y₂) to configure the neurons, θ, the systematic linear encoding function, F(·), and the second linear decoding function, G′(·), so as to minimize

$${f}_{C} ( ; {θ}^{*} ) = arg {min}_{θ} ( {‖ {Y}_{1} - {G}^{′} ( {Y}_{2} , {f}_{C} ( {X}_{3} ; θ ) ) ‖}^{2} ) .$$

Consider a case in which the systematic inference unit A 704A and the systematic inference unit B 704B are associated with an identical failure probability. In this case, an overall training goal may be expressed as a combination of the first training goal and the second training goal discussed hereinbefore,

$${f}_{C} ( ; {θ}^{*} ) = arg {min}_{θ} ( {‖ {Y}_{2} - G ( {Y}_{1} , {f}_{C} ( {X}_{3} ; θ ) ) ‖}^{2} + {‖ {Y}_{1} - {G}^{′} ( {Y}_{2} , {f}_{C} ( {X}_{3} ; θ ) ) ‖}^{2} ) .$$

It is more realistic to consider a case in which the systematic inference unit A 704A and the systematic inference unit B 704B are associated with different failure probabilities. The different failure probabilities may, in part, be due to physical channel differences and differences in computation capacities. For example, the systematic inference unit A 704A may be able to provide most users with a Light-of-Sight (LOS) radio connection, whereas the systematic inference unit B 704B cannot provide most users with a LOS radio connection. For another example, the systematic inference unit A 704A may be much closer to the users than the systematic inference unit B 704B. In both of these examples, the failure probability associated with the systematic inference unit A 704A would be lower than the failure probability associated with the systematic inference unit B 704B. Accordingly, Y₂ would be more likely to be erased (or lost) than Y₁. To compensate for the imbalance in failure probabilities, weights may be inserted into the training goal. For instance, a waited training goal may be expressed as:

$${f}_{C} ( ; {θ}^{*} ) = arg {min}_{θ} ( {β}_{1} \cdot {‖ {Y}_{2} - G ( {Y}_{1} , {f}_{C} ( {X}_{3} ; θ ) ) ‖}^{2} + {β}_{2} \cdot {‖ {Y}_{1} - {G}^{′} ( {Y}_{2} , {f}_{C} ( {X}_{3} ; θ ) ) ‖}^{2} ) .$$

$$where {β}_{1} + {β}_{2} = 1.$$

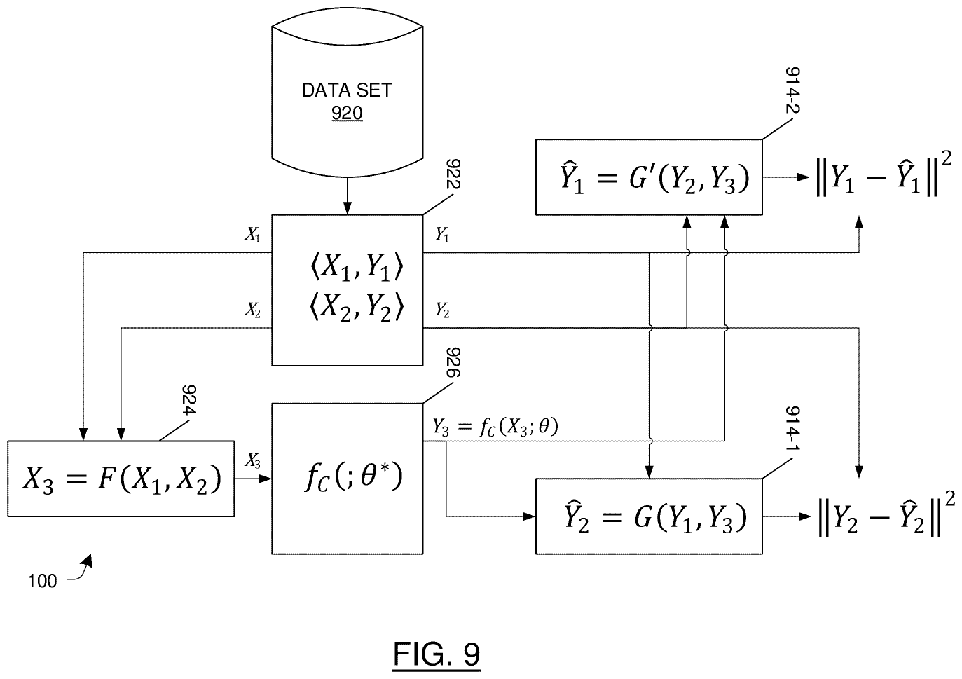

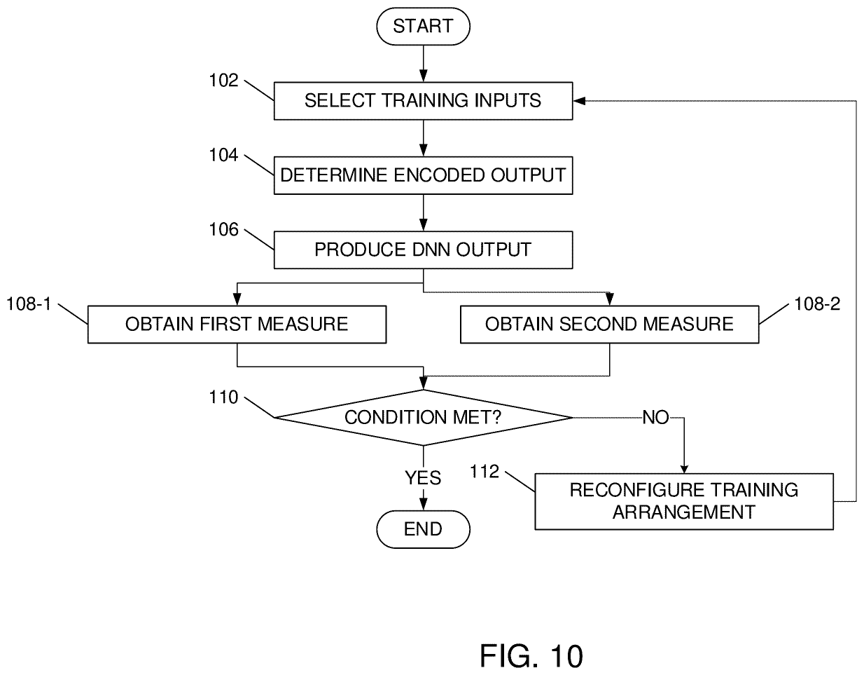

Once the training data set has been established and the training goal has been settled upon, training may proceed. The training may be based on an SGD algorithm using backward propagation. FIG. 9 illustrates a training arrangement 900 for a DNN 926 to be used for a redundant inference unit. Example steps in a training method are illustrated in FIG. 10.

From a training data set 920, a pair 922 of training inputs (X₁, Y₁) and (X₂, Y₂) may be randomly selected (step 1002). A systematic linear encoder 924 may receive training inference requests X₁ and X₂ and determine (step 1004) an encoded output, X₃=F(X₁, X₂). The encoded output, X₃, from the systematic linear encoder 924 may be received, as input to the DNN 926 and used, by the DNN 926, to produce (step 1006) DNN output, Y₃=ƒ_{C}(X₃; θ).

The DNN output, Y₃, may be received at a first linear decoder 914-1 and used to produce Ŷ₂=G(Y₁, Y₃), thereby allowing for a determination of ∥Y₂−Ŷ₂∥². That is, a first measure may be obtained (step 1008-1), where the first measure is representative of the degree to which the estimate, Ŷ₂, is close to the actual Y₂.

The DNN output, Y₃, may be received at a second linear decoder 914-2 and used to produce Ŷ₁=G(Y₂, Y₃), thereby allowing for a determination of ∥Y₁−Ŷ₁∥². That is, a second measure may be obtained (step 1008-2), where the second measure is representative of the degree to which the estimate, Ŷ₁, is close to the actual Y₁.

The measures, ∥Y₂−Ŷ₂∥² and ∥Y₁−Ŷ₁∥², may be used to determine (step 1010) whether the training method of FIG. 10 has defined the function, ƒ_{C}(; θ*), implemented by the DNN 926 to successfully approximate the function ƒ(·), implemented by the systematic inference unit A 704A and the systematic inference unit B 704B.

Upon determining (step 1010) that the training method of FIG. 10 has yet to successfully approximate the function ƒ(·), the measures, ∥Y₂−Ŷ₂∥² and ∥Y₁−Ŷ₁∥², may be employed in the SGD learning algorithm using backward propagation to reconfigure (step 1012) the training arrangement 900 of FIG. 9. The reconfiguring (step 1012) may include reconfiguring the neurons, θ, reconfiguring the systematic linear encoder, F(·), reconfiguring the first linear decoder, G(·), and reconfiguring the second linear decoder, G′(·), so as to improve a degree to which the function, ƒ_{C}(; θ*), implemented by the DNN 926 resembles the function ƒ(·), implemented by the systematic inference unit A 704A and the systematic inference unit B 704B. Subsequent to employing the SGD learning algorithm using backward propagation to reconfigure (step 1012) the training arrangement 900 of FIG. 9, the training method of FIG. 10 may be repeated, starting with making a random selection (step 1002), from the training data set 920, of another pair 922 of training inputs (X₁, Y₁) and (X₂, Y₂).

Upon determining (step 1010) that the training method of FIG. 10 has successfully approximated the function ƒ(·), it may be considered that the redundant inference function, ƒ_{C}(; θ*), has been trained. After the redundant inference function, ƒ_{C}(; θ*), has been trained, for example, using the training method of FIG. 10, the redundant inference function, ƒ_{C}(; θ*), may be installed in the redundant inference unit C 704C. The redundant inference unit C 704C may then be expected to receive X₃=F (X₁, X₂), execute the inference Y₃=ƒ_{C}(X₃; θ*), and then send Y₃ to the requesting user.

It is noted that Ŷ₁ and Ŷ₂ are estimations of Y₁=ƒ(X₁) and Y₂=ƒ(X₂), respectively, rather than the exactly true values. Accordingly, it may be expected that there be “estimation bias” between the true value Y₁ and the estimated value Ŷ₁ and between the true value Y₂ and the estimated value Ŷ₂. Although the goal of training ƒ_{C}(; θ) is to minimize estimation biases, it is recognized that the biases would inevitably undermine the inference accuracy relative to ƒ(X) in theory, the resultant degradation might be still acceptable for most inferences in reality.

To analyze this degradation, a concept of inference reliability may be introduced. An inference accuracy metric that measures the accuracy for each inference may be used in respect of a trained DNN. However, when transmission of each inference request and reception of each inference result is considered, even a successful and highly accurate inference result may, sometimes, be lost, severely delayed, or erased, which results in an unreliable inference, from the perspective of the inference requesting user. When these factors are considered, inference reliability may be used as a metric representative of a quality of a remote inference.

For example, consider the following two cases implementing a coding rate of ⅔ and code length of two. A first case lacks coded inference. If one out of every three inference requests is expected to be lost (or severely delayed) in the first case, the overall inference reliability may be considered to be ˜64%, despite any successfully returned inference having a 96% accuracy. A second case uses coded inference. If one out of every three inference requests is expected to be lost in the second case, it may be considered that nearly all the inference results would either be successfully returned or be estimated. Consequently, the inference accuracy may be considered be around 93%. From the point of view of an application, the case with coded inference is more beneficial.

The method described hereinbefore, with reference to FIG. 10, for training the redundant inference function, ƒ_{C}(; θ*), may be shown to make coded inference feasible and serves as a starting point for a coded inference network.

It is known that the coded inference strategy is more likely to work with modestly sized DNNs than the coded inference strategy is to work with giant DNNs. Unfortunately, arranging a coded inference strategy for giant DNNs is a target for aspects of the present application. Indeed, aspects of the present application are directed to a coded inference network to extend coded inference for use with giant DNNs.

In overview, a giant DNN may be divided into a cascade of smaller sub-DNNs. For example, a 20-layer DNN may be divided into a cascade of four, 5-layer sub-DNNs. The division need not be homogenous. For a first, middle-sized sub-DNN and for the available redundancy units for the first sub-DNN, a coded inference stage could be trained in the way described in conjunction with FIG. 10. A plurality of built, coded inference stages may be connected in a cascade to, thereby, form a coded inference network.

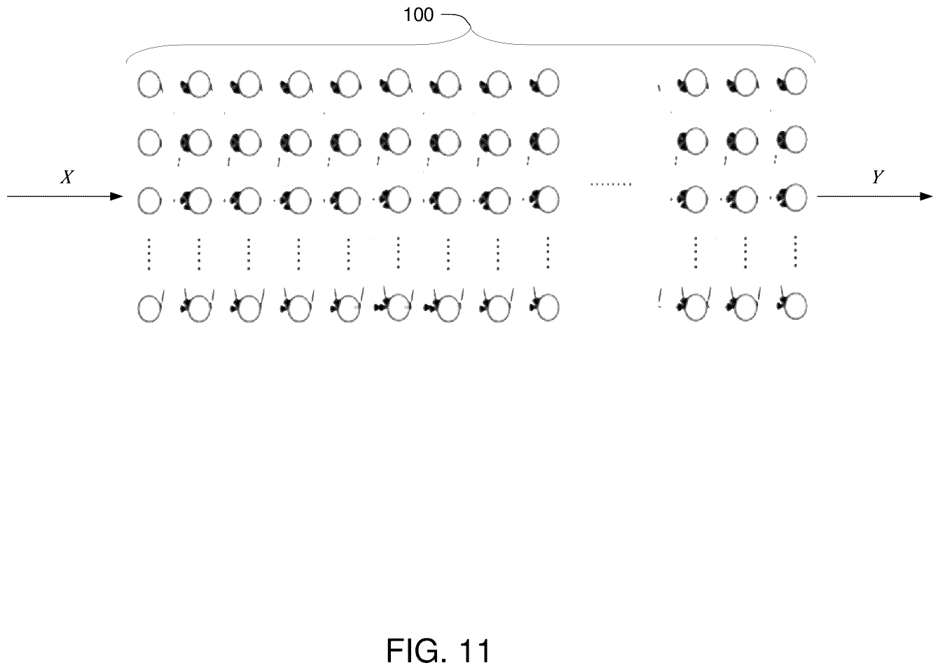

FIG. 11 illustrates a trained giant deep neural network 1100. The trained giant DNN 1100 of FIG. 11 is configured to receive a plurality, K, of inference requests, X, and provide the same number, K, of inference results, Y.

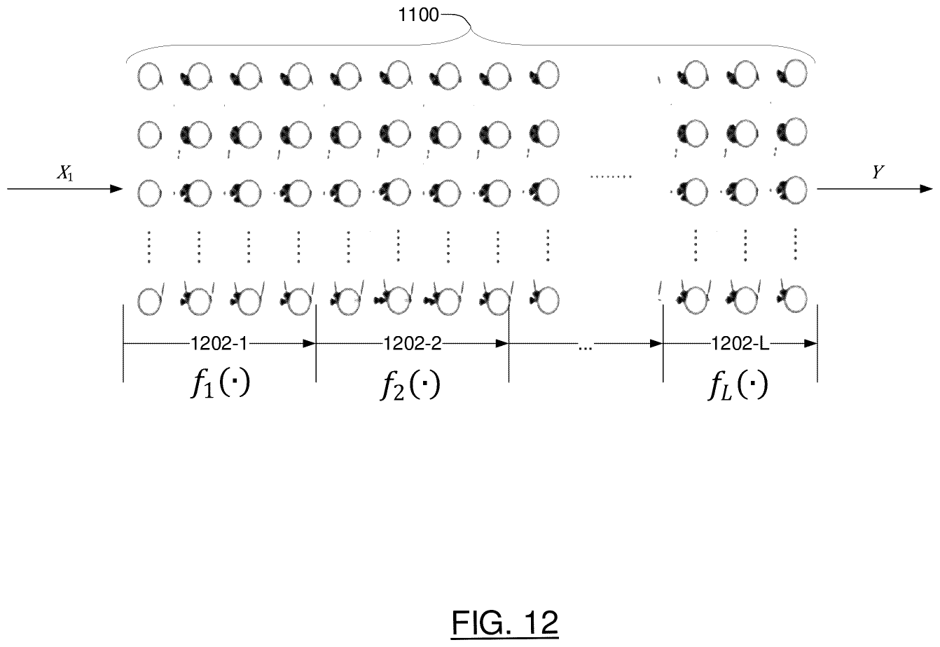

FIG. 12 illustrates a divided trained giant DNN 1200 based on dividing the trained giant DNN 1100 of FIG. 11 into a plurality, L, of partitions 1202-1, 1202-2, . . . , 1202-L suitable for representation by a plurality of coded inference stages. Each of the coded inference stages may be associated with components to implement a respective sub-DNN function ƒ₁ (·), ƒ₂(·), . . . , ƒ_{L}(·) and additional components, to be discussed hereinafter.

In view of the plurality of coded inference stages, a user may send a first set of K inference requests, X₁, to a first coded inference stage and expect the same number, K, of inference results, Y, from a last coded inference stage.

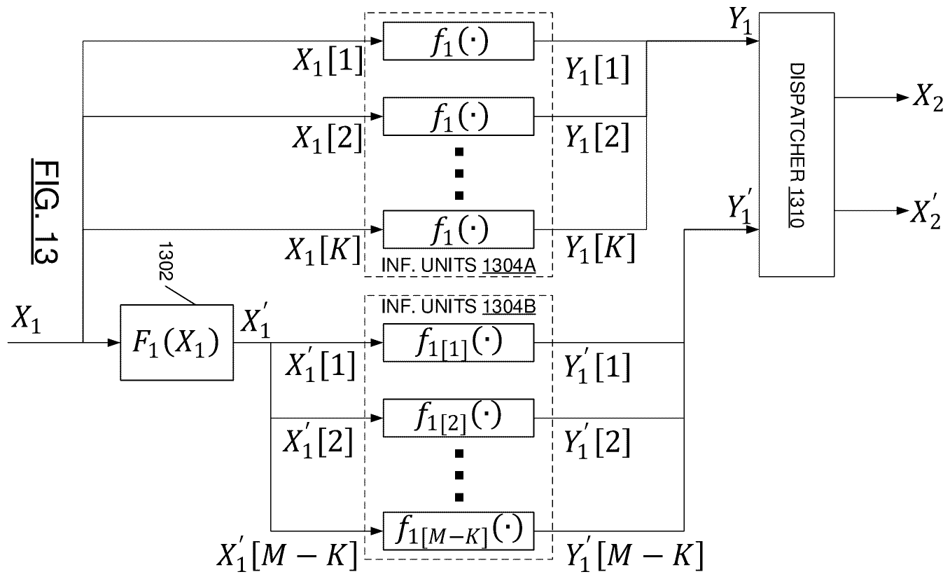

FIG. 13 illustrates example components of a first coded inference stage associated with the first sub-DNN function ƒ₁(·), including a plurality, M₁, of inference units. The plurality of inference units may be divided into a plurality, K, of systematic inference units 1304A and a plurality, M₁-K, of redundant inference units 1304B. Preceding the first coded inference stage is a first linear encoder 1302. Following the first coded inference stage is a second dispatcher 1310. The combination of the plurality of systematic inference units 1304A and the plurality of redundant inference units 1304B may be referenced as the first coded inference stage.

In operation, the first linear encoder 1302 uses a first encoding function F₁ (·) to encode the inference requests, X₁, to obtain X′₁, where X is representative of M₁-K coded inference requests for the redundant inference units 1304B. Generally, the first coded inference stage, represented by M₁ inference units 1304A, 1304B, receives M₁ inference requests (X₁, X′₁). It is expected that the first coded inference stage, associated with the first sub-DNN function ƒ₁(·), will yield inference results (Y₁, Y′₁).

The inference results are, generally, expected to be received by the second dispatcher 1310. However, the inference results, (Y₁, Y′₁), may not reach the second dispatcher 1310 reliably or in a timely manner. Reasons may include a cyclic redundancy check (CRC) failure, a severe delay, one or more of the inference units 1304A, 1304B being temporarily incapable of finishing the inference in time, etc.

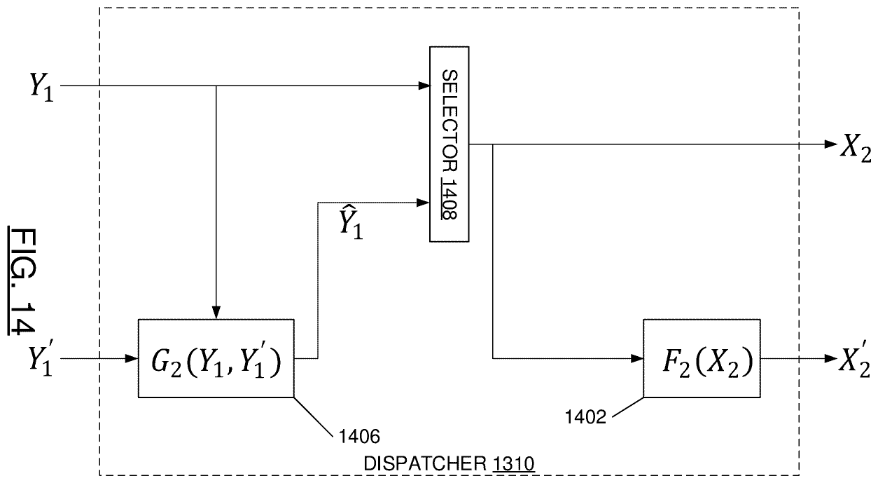

FIG. 14 illustrates example components of the second dispatcher 1310. The second dispatcher 1310 includes a first linear decoder 1406, a selector 1408 and a linear encoder 1402. In operation, the second dispatcher 1310 receives an inference result, Y₁, and a redundant inference result, Y′₁, and produces input for the second coded inference stage associated with the second sub-DNN function ƒ₂ (·). It is expected that the second coded inference stage includes a plurality, M₂, of inference units (not explicitly identified). It is also expected that a dispatcher (not shown) will interpose the second coded inference stage and a subsequent coded inference stage. The plurality of inference units at the second coded inference stage may be divided into a plurality, K, of systematic inference units and a plurality, M₂-K, of redundant inference units. Accordingly, the output of the second dispatcher 1310 includes a second set of K inference requests, X₂, and a second set of M₂-K redundant inference requests, X₂.

The first linear decoder 1406 may implement a decoding function, G₂(·), to obtain an estimate, Ŷ₁, of inference result, Y₁. That is, the first linear decoder 1406 may employ the received redundant inference result, Y′₁, while implementing Ŷ₁=G₂(Y₁, Y′₁). The selector 1408 of the second dispatcher 1310 determines the second set of K inference requests, X₂. The selector 1408 may set X₂=Y₁ if Y₁ is considered, by the selector 1408, to be well received. Alternatively, if Y₁ is not considered, by the selector 1408, to be well received, the selector 1408 may set
X₂=Ŷ₁. There may be several criteria on which to base an assessment regarding whether an inference result has been well received. For example, an inference result may be considered well received on the basis of a cyclic redundancy check (CRC).

The selector 1408 may consider and inference result, either Y₁ or Y′₁, to be well received if the inference result reaches the selector 1408 within predetermined latency conditions. For example, both Y₁ and Y′₁ may be encoded, modulated, pass through a channel (wireless or wired), demodulated and decoded (CRC checked) on a path from the inference units 1304A, 1304B to the dispatcher 1310. Notably, retransmission may be requested, by the dispatcher 1310, responsive to latency conditions not being met.

In a case wherein the selector 1408 considers both Y₁ and Ŷ₁ to be well received, the selector 1408 may be expected to set X₂=Y₁. The selector 1408 gives a priority to Y₁ that is higher than a priority given to Ŷ₁, because Y₁ is a genuine inference result and Ŷ₁ is an estimated inference result. In a case wherein the selector 1408 considers only Y₁ to be well received, the selector 1408 may be expected to set X₂=Y₁. In a case wherein the selector 1408 considers only Ŷ₁ to be well received, the selector 1408 may be expected to set X₂=Ŷ₁.

The second dispatcher 1310 also encodes the second set of K inference requests, X₂, using the linear encoder 1402. In particular, the linear encoder 1402 implements a second encoding function, F₂(·), to encode the inference request, X₂, to obtain X′₂, where X′₂ is representative of M₂-K coded inference requests for the redundant inference units in the second coded inference stage. The first second dispatcher 1310 may then transmit the inference requests, (X₂, X′₂), to the M₂ inference units that are supposed to yield (Y₂, Y′₂) inference results for the second sub-DNN and send the inference results to the second dispatcher.

The last coded inference stage includes ML inference units (not shown) that are expected to produce inference results (Y_{L}, Y′_{L}), in a manner familiar in view of the manner that the M₁ inference units 1304A, 1304B of FIG. 13 are expected to produce inference results (Y₁, Y′₁).

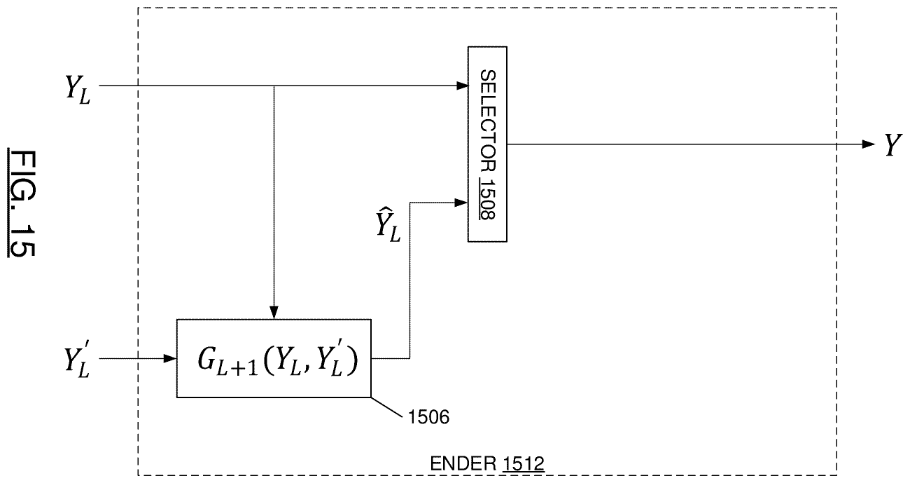

FIG. 15 illustrates example components of an ender 1512. The ender 1512 may be considered similar to the second dispatcher 1310 of FIG. 14, but lacking an encoder, since there is no further stage for which to encode the output. The ender 1512 is positioned following the M_{L} inference units of the last coded inference stage. The ender 1512 includes a last linear decoder 1506 and a selector 1508.

In operation, the ender 1512 receives an inference result, Y_{L}, and a redundant inference result, Y′_{L}, and produces output, Y, for the divided trained giant DNN 1200 of FIG. 12. Recall that the divided trained giant DNN 1200 is expected to output a set of K inference results, Y.

The last linear decoder 1506 of the ender 1512 may implement a decoding function, G_{L+1}(·), to obtain an estimate, Ŷ_{L}, of inference result, Y_{L}. That is, the last linear decoder 1506 may employ the received redundant inference result, Y′₁, while implementing Ŷ_{L}=G_{L+1} (Y_{L}, Y′_{L}). The selector 1508 of the ender 1512 determines the set of K inference results, Y. The selector 1408 may set Y=Y_{L} if Y_{L} is considered, by the selector 1508, to be well received. Alternatively, if Y_{L} is not considered, by the selector 1508, to be well received, the selector 1508 may set Y=ŶL. There may be several criteria on which to base an assessment regarding whether an inference result has been well received. For example, an inference result may be considered well received on the basis of a CRC.

The selector 1508 may consider and inference result, either Y_{L} or ŶL, to be well received if the inference result reaches the selector 1508 within predetermined latency conditions. For example, both Y_{L} and Y′_{L} may be encoded, modulated, pass through a channel (wireless or wired), demodulated and decoded (CRC checked) on a path to the ender 1512. Notably, retransmission may be requested, by the ender 1512, responsive to latency conditions not being met.

In a case wherein the selector 1508 considers both Y_{L} and Ŷ_{L} to be well received, the selector 1508 may be expected to set Y=Y_{L}. The selector 1508 gives a priority to Y′_{L} that is higher than a priority given to Ŷ_{L}, because Y_{L} is a genuine inference result and Ŷ_{L} is an estimated inference result. In a case wherein the selector 1508 considers only Y_{L} to be well received, the selector 1508 may be expected to set Y=Y_{L}. In a case wherein the selector 1508 considers only Ŷ_{L} to be well received, the selector 1508 may be expected to set Y=Ŷ_{L}.

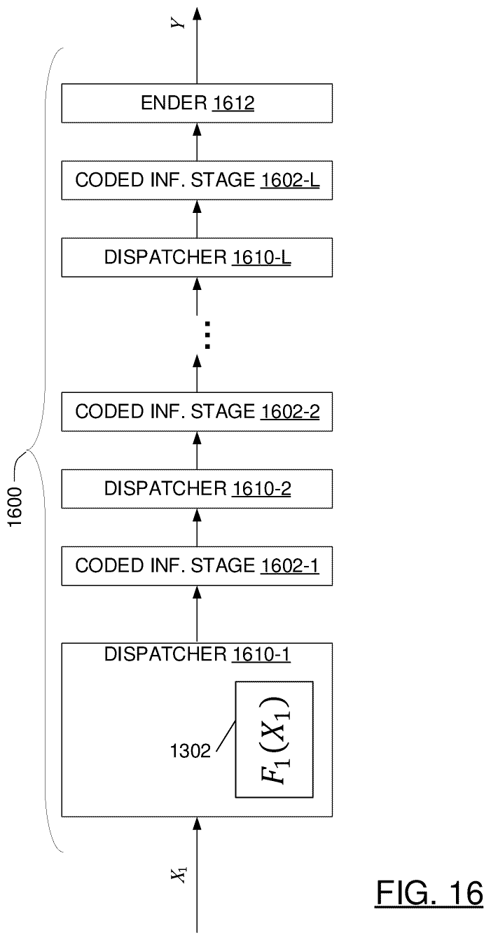

FIG. 16 illustrates a coded inference network 1600 that brings together the components discussed in view of FIGS. 12, 13, 14 and 15. A first coded inference stage 1602-1, a second coded inference stage 1602-2 and a last coded inference stage 1602-L are representative of respective partitions 1202-1, 1202-2 and 1202-L from FIG. 12. The first linear encoder 1302, familiar from FIG. 13, is illustrated, in FIG. 16, as being part of a first dispatcher 1610-1. Output from the first dispatcher 1610-1 is received at the first coded inference stage 1602-1. Output from the first coded inference stage 1602-1 is received at a second dispatcher 1610-2, which may be similar to the second dispatcher 1310, whose details are familiar from FIG. 14. Output from the second dispatcher 1610-2 are received at the second coded inference stage 1602-2. The cascade continues until the last coded inference stage 1602-L receives input from a last dispatcher 1610-L. Output from the last coded inference stage 1602-L is received at an ender 1612, similar to the ender 1512, familiar from FIG. 15. Output from the ender 1612 is the set of K inference results, Y.

Note that the coding rates from one coded inference stage 1602 to another coded inference stage 1602 may be different. Due to limitations on computation at a user and radio transmission bandwidth from this user to the core network, the coding rate

$$\frac{K}{{M}_{1}}$$

may not be very low. But the inference units are not terminal. Consequently, the inference units can implement more redundancy. It follows that the coding rates in the core network can be much lower than

$$\frac{K}{{M}_{1}} .$$

However, it is known that a giant DNN may contain more than 100 billion neurons. Suppose that such a giant DNN is divided into 10 coded inference stages. Each coded inference stage would then contain about 10 billion neurons. Consider implementation of a ⅔ coding rate redundancy, i.e., one out of every three inference units is a redundant inference unit. It can be shown that a divided trained giant DNN implementing a coded inference network with a ⅔ coding rate redundancy would employ over 140 billon neurons. Although a coded inference network would save a long-distance transmission from an end user to a remote data center and would establish a degree of inference reliability by redundancy, it seems, at first sight, that such a coded inference network, with so many more neurons, would consume more energy than the giant DNN. Hereinafter, it will be argued that a coded inference network would have energy-consumption benefits in at least two aspects.

The inference units in a coded inference network may be established as well-designed, specific-inference circuits. It can be shown that performing inference on a specific-inference circuit consumes much less energy than performing inference on a GPU in a data center.

It may be shown to be easier to power and cool a number of small, distributed inference units than it is to power and cool a great data center. Cooling a great data center takes up to 40% of its entire energy.

In building a powerful data center for a giant DNN for both training and referencing cycles, a stable energy supply and advanced cooling system are typically mandated.

In a coded inference network, each inference unit is physically distant from each other and powered by a normal energy supply and cooled by a normal cooling system.

Moreover, thanks to the redundancy, even if several inference units are powered down (due to accidents or malicious attacks), the entire coded inference network could be still working.

Future 6G wireless networks, especially those 6G wireless networks employing millimeter wave (mmWAVE) technology, may be expected to provide abundant radio bandwidth, dense connections and wide coverage. Accordingly, such 6G wireless networks may be viewed as good candidates for helping to efficiently realize coded inference networks.

With regard to a situation wherein a user has only one inference request per time, coding theory indicates that a repetitive code is the optimal code. That is, simply sending a single inference request to M inference units results in a

$$\frac{1}{M}$$

coding rate. It is only valid when the user has more than one inference requests to send per time that there is a place for a well-designed linear encoding scheme (F(·), see the systematic linear encoder 924 in FIG. 9 and the first linear encoder 1302 in FIG. 13).

Given that the benefit of a combination of linear encoding and inference units is associated with more than one inference requests being sent per time, aspects of the present application relate to using a TRP as a surrogate.

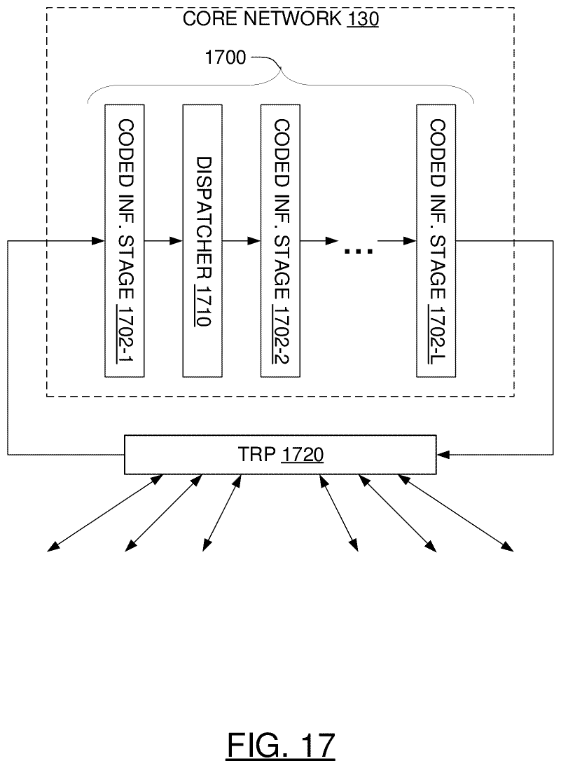

FIG. 17 illustrates a TRP 1770 interfacing with a coded inference network 1700. The coded inference network 1700 is illustrated as being part of a core network 130, but much more probably, the coded inference network 1700 may be implemented on the edge of the core network 130. The coded inference network 1700 includes a cascade including a first coded inference stage 1702-1, a dispatcher 1710, a second coded inference stage 1702-2 and a last coded inference stage 1702-L. The first coded inference stage 1702-1 is arranged to receive input from the TRP 1770 and the last coded inference stage 1702-L is arranged to provide output to the TRP 1770.

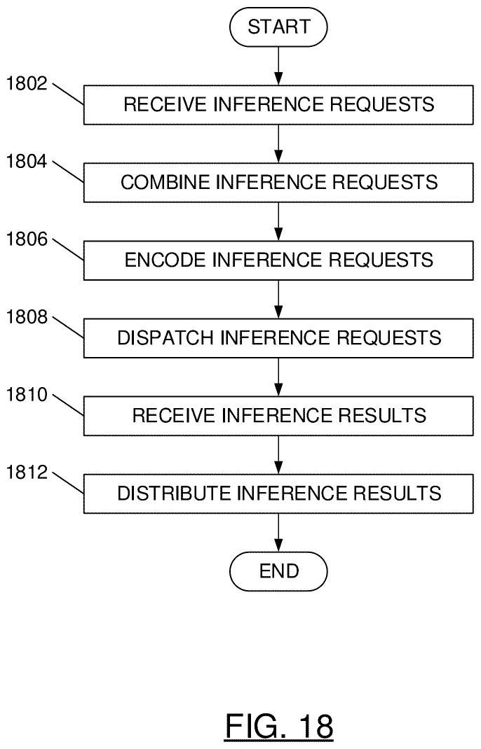

FIG. 18 illustrates example steps in a method, for carrying out at the TRP 1770, of interfacing with the coded inference network 1700. The TRP 1770 may initially receive (step 1802) a plurality of inference requests from a plurality of different sources (not shown in FIG. 17). The sources may be called users or EDs 110. The TRP 1770 may be configured to combine (step 1804) the received inference requests of the same type into a vector of inference requests. The step of combining (step 1804) inference requests of the same type, among a plurality of received inference requests, is intended to be a step that is transparent to the users from which the inference requests have been received (step 1802).

The TRP 1770 may also be configured act as the first dispatcher 1610-1 (see FIG. 16) to encode (step 1806) the vector of inference requests using a well-designed linear code and dispatch (step 1808) systematic inference requests and redundant coded inference requests to appropriate inference units (both systematic inference units and redundant inference units) in the first coded inference stage 1702-1. The TRP 1770 may also be configured to act as an ender (see the ender 1510 in FIG. 15 and FIG. 16) to receive (step 1810), from the last coded inference stage 1702-L, a vector of inference results and then distribute (step 1812) individual inference results to respective users among the plurality of different users.

The TRP 1770 may be connected to the first coded inference stage 1702-1 either in a wired or a wireless way. Similarly, various coded inference stages 1702 may be connected either in a wired or a wireless way. Wired connections between coded inference stages 1702 may be accomplished using a cable or a fiber. One or more coded inference stages 1702 may be directly installed at the TRP 1770.

Each coded inference stage 1702 is expected, In a manner consistent with the coded inference stages 1302 of FIG. 13, to be made up of a plurality of inference units, including systematic inference units and redundant inference units. Management of the inference units may be handled by the core network 130. That is, the core network 130 may schedule the inference units, the core network 130 may configure the inference units, the core network 130 may update the inference units, the core network 130 may indicate, to each inference unit, a particular inference function (either systematic or redundant), and the core network 130 may regularize the inference units that makes up a single coded inference stage 1702.

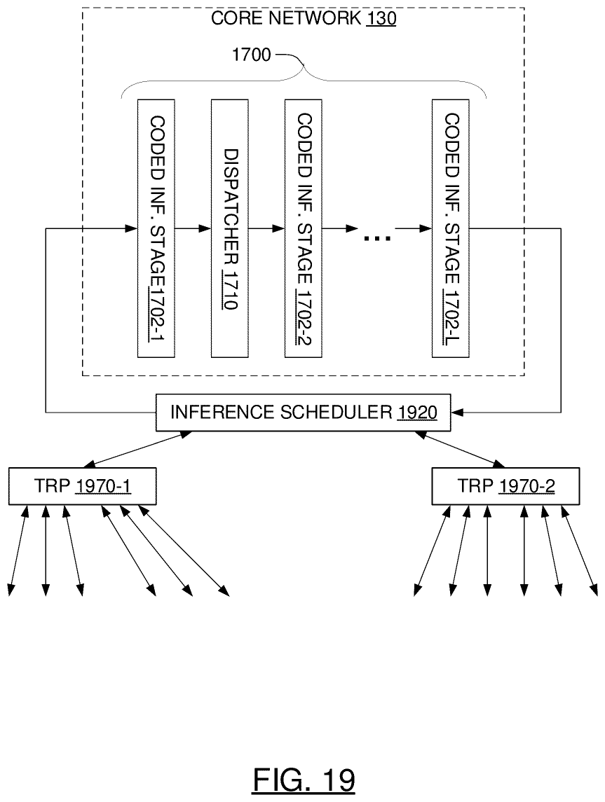

The coded inference network 1700 is illustrated in FIG. 19 as serving more than one TRP. FIG. 19 illustrates a first TRP 1970-1 and a second TRP 1970-2, but it should be understood that these two TRPs 1970 are representative of a potential plurality of TRPs 1970. In the case illustrated in FIG. 19, an inference scheduler 1920 has been inserted to manage inference requests destined for the coded inference network 1700. The inference scheduler 1920 may be found to be of particular use when the TRPs 1970 intend to communicate with the coded inference network 1700 wirelessly. In a manner consistent with the step of combining (step 1804) inference requests of the same type at the TRP 1770 of FIG. 17, the inference scheduler 1920 of FIG. 19, may also combine inference requests of the same type, among a plurality of received inference requests, thereby relieving the TRPs 1970 of FIG. 19 of the burden of the combining step.

It is known that a coded inference network may be considered to be software-like (software-defined) in that inference units in each of the coded inferences stages may be implemented in a manner that is both programmable and scalable.

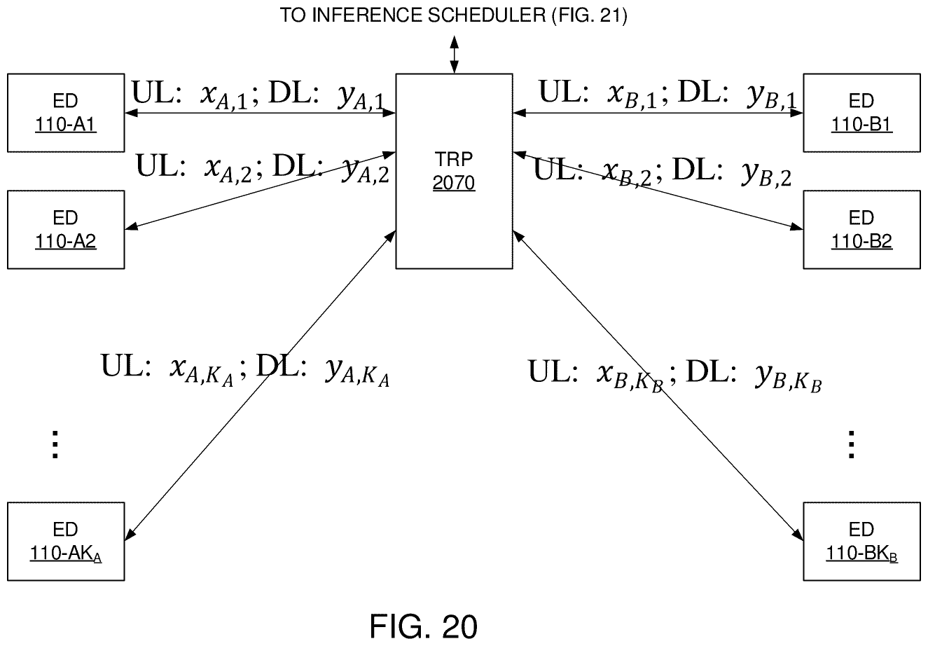

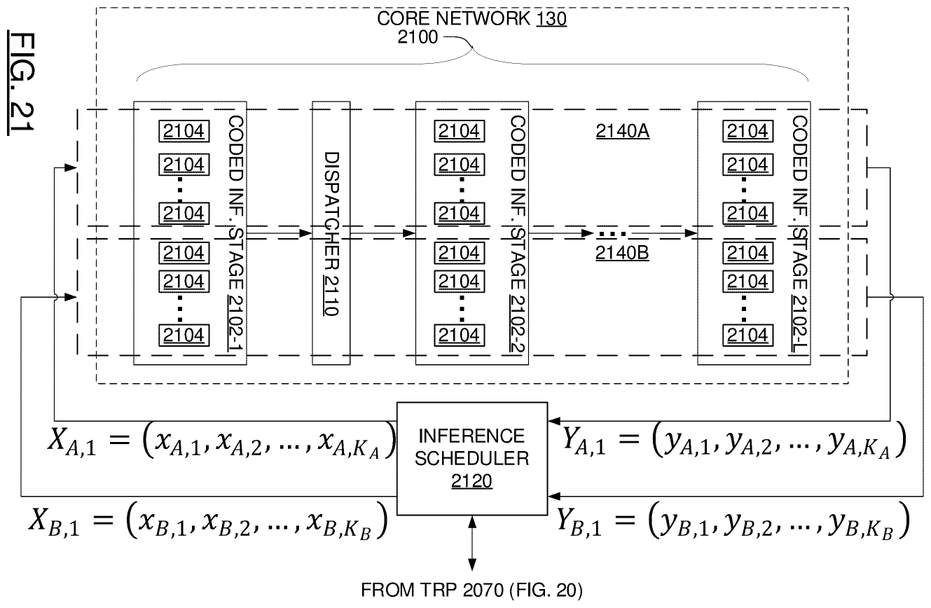

FIG. 20 and FIG. 21 together illustrate a scenario wherein inference requests from two distinct sets of EDs 110 are aggregated at a TRP 2070 and managed at an inference scheduler 2120 for a collection 2100 of coded inference stages 2102 and dispatchers (an example dispatcher 2110 is illustrated) implementing more than one coded inference network 2140. In particular, the collection 2100 of coded inference stages 2102 in FIG. 21 implements a first coded inference network 2140A and a second coded inference network 2140B. The collection 2100 of coded inference stages 2102 includes a first coded inference stage 2102-1, a second coded inference stage 2102-2 and a last coded inference stage 2102-L. Consistent with the coded inference networks described hereinbefore, each of the coded inference stages 2102 includes a respective plurality of inference units 2104. Each plurality of inference units 2104 includes systematic inference units and redundant inference units.

FIG. 20 illustrates a first set of EDs 110-A1, 110-A2, . . . , 110-AK_{A} (individually or collectively 110-A) and a second set of EDs 110-B1, 110-B2, . . . , 110-BK_{B} (individually or collectively 110-B). The first set of EDs 110-A may issue inference requests of a first type (“type A”). The second set of EDs 110-B may issue inference requests of a second type (“type B”). As illustrated in FIG. 20, the first set of EDs 110-A1, 110-A2, . . . , 110-AK_{A} issue inference requests x_{A,1}, x_{A,2}, . . . , x_{A,K}_{_{A}} respectively. Additionally, the second set of EDs 110-B1, 110-B2, . . . , 110-BK_{B} issue inference requests x_{B,1}, x_{B,2}, . . . , x_{B,K}_{_{B}} respectively. The TRP 2070 of FIG. 20 may be configured to aggregate the inference requests of the two types and pass the inference requests to the inference scheduler 2120 of FIG. 21.

The inference scheduler 2120 of FIG. 21 may be configured to manage the received inference requests to send a coded vector (a “codeword” in coding theory) of the inference requests of a particular type to the coded inference network 2140 that is configured to produce inference results for the inference requests of the particular type. That is, the inference scheduler 2120 may send a coded vector, X_{A,1}, to the first coded inference network 2140A, where the coded vector, X_{A,1}, is a function of the received inference requests, X_{A,1}=(x_{A,1}, x_{A,2}, . . . , x_{A,K}_{_{A}}). Similarly, the inference scheduler 2120 may send a coded vector, X_{B,1}, to the second coded inference network 2140B, where the coded vector, X_{B,1}, is a function of the received inference requests, X_{B,1}=(x_{B,1}, x_{B,2}, . . . , X_{B,K}_{_{B}}).

The first coded inference network 2140A produces a coded vector, Y_{A,1}, of inference results, where Y_{A,1}=(Y_{A,1}, Y_{A,2}, . . . , Y_{A,K}_{_{A}}). The second coded inference network 2140B produces a coded vector, Y_{B,1}, of inference results, where
Y_{B,1}=(y_{B,1}, y_{B,2}, . . . , y_{B,K}_{_{B}}). The coded vectors of inference results are received by the inference scheduler 2120 and passed to the TRP 2070. The TRP 2070 may de-aggregate the inference results and send individual inference results of the first type y_{A,1}, y_{A,2}, . . . , y_{A,K}_{_{A}} to respective EDS among the first set of EDs 110-A1, 110-A2, . . . , 110-AK_{A} and individual inference results of the second type y_{B,1}, y_{B,2}, . . . , y_{B,K}_{_{B}} to respective EDs among the second set of EDs 110-B1, 110-B2, . . . , 110-BK_{B}.

Notably, the first coded inference network 2140A and the second coded inference network 2140B may be executed using the same physical inference resources. The first coded inference network 2140A and the second coded inference network 2140B may overlap on the scope of the physical inference resources. For example, the first coded inference network 2140A may execute inference units for both coded inference networks 2140A, 2140B at the same time. The inference units 2104 for the first coded inference network 2140A may take 80% resource, while the second coded inference network 2140B takes the remaining 20%.

The coding scheme used to produce the coded vectors, X_{B,1} and X_{B,1} may be any coding scheme among traditional linear codes, such as polar code, Galley code, etc.

As discussed hereinbefore, it is practical to wirelessly connect inference units and dispatchers in a coded inference network. It may be supposed that most inference units and dispatchers are associated with fixed stations, with no mobility or low mobility. Furthermore, the fixed stations may be equipped with antenna sets for mmWAVE beamforming. Thanks to a linear coding scheme, a MIMO beamforming technology with mmWAVE can be used to not only transmit both the intermediate inference requests and the intermediate inference results but also realize a linear encoder and decoder in a radio analog signal domain.

In the example of ⅔ coding rate and coding length of 2, we suppose a simple linear encoder (X₁, X₂, X₃)=F(X₁, X₂): X₃=X₁+X₂ and linear decoders:
Ŷ₁=G(ƒ(X₂), ƒ_{C}(X₃))=ƒ_{C}(X₃)−ƒ(X₂) and Ŷ₂=G′(ƒ(X₁), ƒ_{C}(X₃))=ƒ_{C}(X₃)−ƒ(X₁). A user or a first dispatcher can generate four transmission beams. Each of the three inference units may be understood to have one receiving beams.

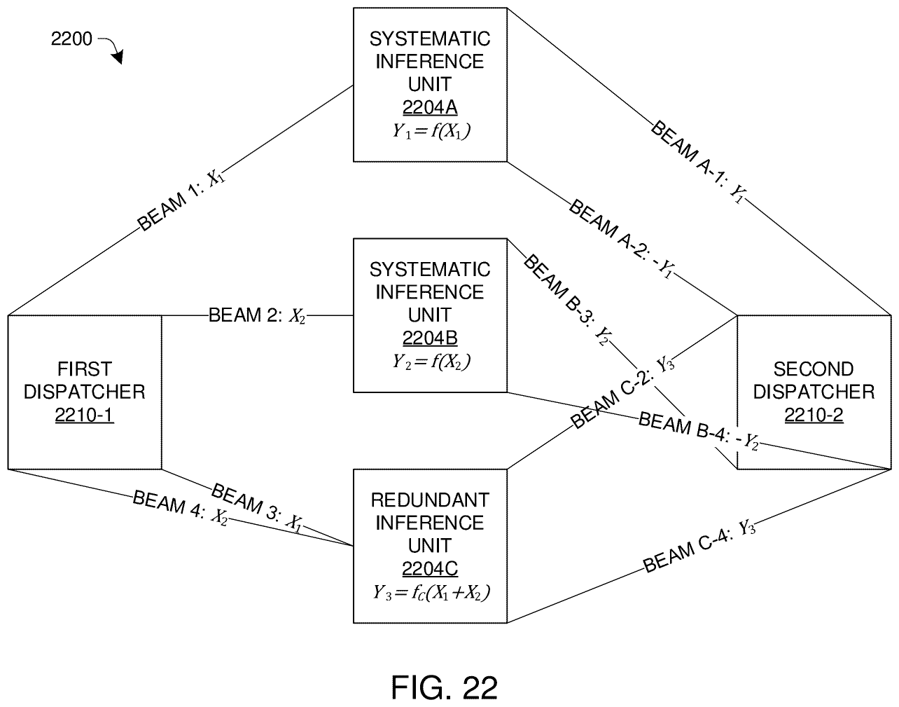

An example distribution of beams is illustrated in FIG. 22. A coded inference network 2200 illustrated in FIG. 22 includes a first dispatcher 2210-1 and a second dispatcher 2210-2 interposed by three inference units: a first systematic inference unit 2204A; a second systematic inference unit 2204B; and a redundant inference unit 2204C.

Beam 1 of the first dispatcher 2210-1 points to the systematic inference unit 2204A and transmits a systematic inference request analog signal X₁ to the systematic inference unit, which implements ƒ(X₁).

Beam 2 of the first dispatcher 2210-1 points to the second systematic inference unit 2204B and transmits a systematic inference request analog signal X₂ to the second systematic inference unit 2204B, which implements ƒ(X₂).

Beam 3 of the first dispatcher 2210-1 points to the redundant inference unit 2204C and transmits the inference request analog signal X₁ to the redundant inference unit 2204C, which implements ƒ_{C}(·).

Beam 4 of the first dispatcher 2210-1 points to the redundant inference unit 2204C and transmits the inference request analog signal X₂ to the redundant inference unit 2204C, which implements ƒ_{C}(·).

The beam 3 and beam 4 may be carefully synchronized by time advances and power weighted by transmission power gain and spacious angle such that the two analog signals, X₁ and X₂, would be added naturally into X₁+X₂ at the input of the redundant inference unit 2204C.

The three inference units 2204 may operate in the analog domain to carry out a forward inference operation.

The systematic inference unit 2204A will have two transmission beams to the second dispatcher 2210-2 (or to the ender). A first transmission beam A-1 of first the systematic inference unit 2204A points to a receiving beam 1 of the second dispatcher 2210-2 and transmits an inference result analog signal Y₁=ƒ(X₁). A second transmission beam A-2 of the first systematic inference unit 2204A points to a receiving beam 2 of the second dispatcher 2210-2 and transmits an inverse of the inference result analog signal −Y₁=−ƒ(X₁).

The second systematic inference unit 2204B will have two transmission beams to the second dispatcher 2210-2 (or to the ender). A first transmission beam B-3 of the second systematic inference unit 2204B points to a receiving beam 3 of the second dispatcher 2210-2 and transmits an inference result analog signal Y₂=ƒ(X₂). A second transmission beam B-4 of the systematic inference unit B points to a receiving beam 4 of the second dispatcher 2210-2 and transmits an inverse of the inference result analog signal −Y₂=−ƒ(X₂).

The redundant inference unit 2204C will have two transmission beams to the second dispatcher 2210-2 (or to the ender). A first transmission beam C-2 of the redundant inference unit 2204C points to the receiving beam 2 of the second dispatcher 2210-2 and transmits an inference result analog signal Y₃=ƒ_{C}(X₃). A second transmission beam C-4 of the redundant inference unit 2204C points to the receiving beam 4 of the second dispatcher 2210-2 and transmits the inference result analog signal Y₃=ƒ_{C}(X₃).

The beam A-2 and beam C-2 may be carefully synchronized by time advances and power weighted by transmission power gain such that the two inference result analog signals, −Y₁=−ƒ(X₁) and Y₃=ƒ_{C}(X₃), would be added naturally into ƒ_{C}(X₃)−ƒ(X₁) at the input (receiving beam 2) of the second dispatcher 2210-2.

The beam B-4 and beam C-4 may be carefully synchronized by time advances and power weighted by transmission power gain such that the two inference result analog signals, −Y₂=−ƒ(X₂) and Y₃=ƒ_{C}(X₃), would be added naturally into ƒ_{C}(X₃)−ƒ(X₂) at the input (receiving beam 4) of the second dispatcher 2210-2.

It follows that the second dispatcher 2210-2 has the inference result analog signal Y₁ at receiving beam 1, an estimated analog signal Ŷ₂ at its receiving beam 2, the inference result analog signal Y₂ at its receiving beam 3 and an estimated analog signal Ŷ₁ at its receiving beam 4. The second dispatcher 2210-2 can implement a selector to decide which among the received analog signals to select on the basis of the respective signal strengths. The second dispatcher 2210-2 may be realized by a simple switching circuit.

In the example presented in FIG. 22, the first dispatcher 2210-1 has four transmission beams and the second dispatcher 2210-2 has four receiving beams, while each inference unit 2204 has two transmission beams and one receiving beam. The specification of these beam quantities establishes coding rate and code length to be supported by the coded inference network 2200.

Fortunately, it is less expensive to increase the number of beams in mmWAVE bandwidth than it is to increase the number of beams in sub-6 GHZ bands. In particular, for a no-mobility station, power gain and timing advance may be statistically tuned before the coded inference network is used. In most cases, the connection among dispatchers and inference unit stations are light-of-sight.

It is known to be expensive to train a giant DNN from scratch. The original idea to build a giant DNN is to avoid any new training as much as possible. However, certain giant DNNs are still evolving in terms of the scope of the tasks and the data set. New tasks may be added; old tasks may be improved by new data sets. It is expected that frequent updates will be very common and routine.

Based on studies related to local learning and transfer learning and many practical observations, if a total DNN architecture is subjected to no major changes, most updates may be expected to lead to changes in the neurons on the later layers that are more significant than changes, if any, in the earlier layers. It follows that the later coded inference stages of the coded inference network representative of the giant DNN would be more likely to be changed to reflect the changes to the later layers in the giant DNN. Therefore, from the perspective of the coded inference network, the changes are expected to be implemented very locally or even isolated to later coded inference stages. For a mature coded inference network, most inference units, especially in the beginning stages, would be expected to remain static for a time period, whereas only the later coded inference stages may be subjected to occasional changes and reconfiguration.

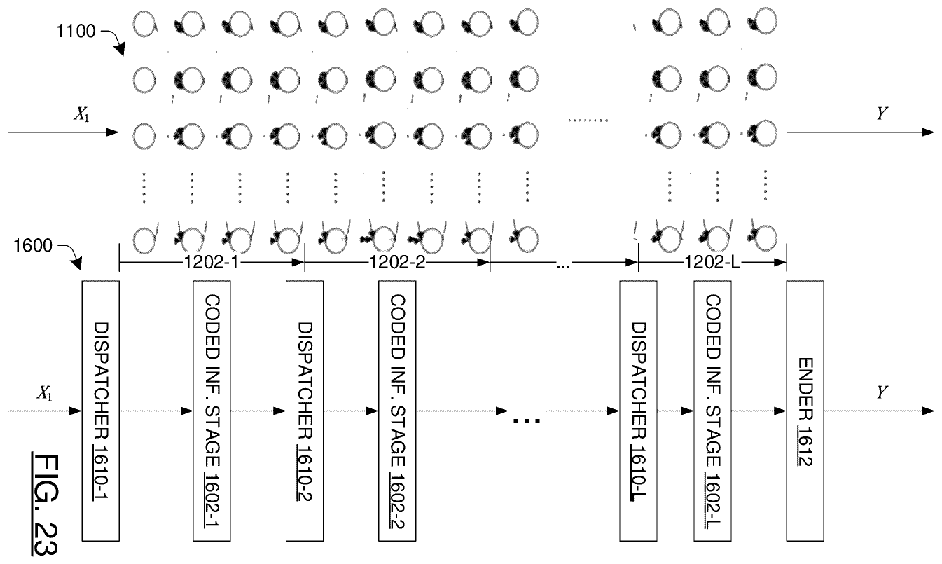

Consider FIG. 23, which illustrates the trained giant deep neural network 1100 from FIG. 11 and the coded inference network 1600 from FIG. 16. The total DNN architecture the trained giant deep neural network 1100 may be subjected to no major changes. However, minor updates may be expected to lead to changes in the neurons on the last partition 1202-L that are more significant than changes, if any, in the earlier partitions 1202. It follows that the last coded inference stage 1602-L would be more likely to be changed to reflect the changes to the last partition 1202-L. Therefore, from the perspective of the coded inference network 1600, the changes are expected to be implemented very locally or even isolated to later coded inference stages 1602.

Setting up a coded inference network to be representative of a giant DNN involves partitioning the giant DNN into several partitions and then configuring a coded inference stage for each partition. The coded inference network to be set up is understood to be allowed to use a total inference resource. Factors that will have bearing on the partitioning of the giant DNN for representation by coded inference stages in the coded inference network include: number of the inference units; number of dispatchers; number of Tx/Rx beams of the inference units; and number of Tx/Rx beams of the dispatchers.

An initial step in setting up the coded inference network relates to deciding upon a linear coding scheme (code length, coding rate, encoder and decoder).

A subsequent step involves training the redundant functions (DNNs) on the redundant inference units for all of the coded inference stages. Reverse-learning may be used for this training and the reverse-learning may accomplished offline.

After the reverse-learning for the redundant functions (DNNs) is complete, the systematic inference units and the redundant inference units may be configured. The configuring involves determining forward-only DNN coefficients, timing advancements and power gain on Tx beams, etc.

After the coded inference network is ready, a scheduler may be established to manage the inference tasks.

The coded inference network, once set up, may be altered responsive to changes in the corresponding giant DNN. Altering the coded inference network may be expected to start with find the first coded inference stage to be affected by the changes. Then, reverse-learning may be redone for the first coded inference stage to be affected by the changes and each subsequent coded inference stage. Fortunately, the changes on the giant DNN are more likely to take place on the last several layers, which corresponds to the last coded inference stage.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1-20. (canceled)

21. A method of managing a plurality of inference requests indicated associated with a coded inference network representative of a deep neural network (DNN), the coded inference network comprising a first coded inference stage and a last coded inference stage, the first coded inference stage implementing a first non-linear function representative of a first sub-DNN of the DNN, the last coded inference stage implementing a last non-linear function representative of a last sub-DNN of the DNN, the method comprising:
receiving, from a particular source, a particular inference request;
encoding the plurality of inference requests, the plurality of inference requests comprising the particular inference request, to form a plurality of coded inference requests, wherein the encoding is specific to the first coded inference stage;
transmitting, to the first coded inference stage, the inference requests and the coded inference requests;
receiving, from the last coded inference stage, a plurality of inference results and a plurality of redundant inference results;
decoding the plurality of inference results and the plurality of estimated inference results to form a plurality of estimated inference results, wherein the decoding is specific to the last coded inference stage;
selecting either the plurality of inference results or the plurality of estimated inference results, thereby generating a plurality of selected inference results; and
transmitting, to the particular source, a particular inference result corresponding to the particular inference request, the particular inference result selected from among the plurality of selected inference results.

22. The method of claim 21, wherein the transmitting the plurality of inference requests and the plurality of encoded inference requests to the first coded inference stage uses a wireless communication link.

23. The method of claim 21, wherein the transmitting the plurality of inference requests and the plurality of encoded inference requests to the first coded inference stage uses a wired communication link.

24. The method of claim 21, wherein the receiving the plurality of inference results and the plurality of estimated inference results from the last coded inference stage uses a wireless communication link.

25. The method of claim 21, wherein the receiving the plurality of inference results and the plurality of estimated inference results from the last coded inference stage uses a wired communication link.

26. The method of claim 21, wherein at least one of the encoding the inference request or the decoding the plurality of estimated inference results comprises employing a linear code.

27. The method of claim 26, further comprising implementing at least one of the encoding or the decoding using beamforming.

28. The method of claim 21, further comprising:
receiving the plurality of inference requests from a plurality of sources; and
transmitting the plurality of selected inference results by distributing, among the plurality of sources, respective corresponding inference results among the plurality of selected inference results.

29. The method of claim 21, wherein the selecting either the plurality of inference results or the plurality of estimated inference results is based on at least one of a cyclic redundancy check on the plurality of inference results and a cyclic redundancy check on the plurality of estimated inference results or latency conditions being met.

30. An apparatus comprising:
at least one memory storing instructions;
at least one processor caused, by executing the instructions, to manage a plurality of inference requests indicated associated with a coded inference network representative of a deep neural network (DNN), the coded inference network comprising a first coded inference stage and a last coded inference stage, the first coded inference stage implementing a first non-linear function representative of a first sub-DNN of the DNN, the last coded inference stage implementing a last non-linear function representative of a last sub-DNN of the DNN, wherein to manage the plurality of inference requests the at least one processor causes the apparatus to:
receive, from a particular source, a particular inference request;
encode the plurality of inference requests, the plurality of inference requests comprising the particular inference request, to form a plurality of coded inference requests, wherein the encoding is specific to the first coded inference stage;
transmit, to the first coded inference stage, the inference requests and the coded inference requests;
receive, from the last coded inference stage, a plurality of inference results and a plurality of redundant inference results;
decode the plurality of inference results and the plurality of estimated inference results to form a plurality of estimated inference results, wherein the decoding is specific to the last coded inference stage;
select either the plurality of inference results or the plurality of estimated inference results, thereby generating a plurality of selected inference results; and
transmit, to the particular source, a particular inference result corresponding to the particular inference request, the particular inference result selected from among the plurality of selected inference results.

31. The apparatus of claim 30, further comprising a transmitter and wherein to transmit, to the first coded inference stage, the inference requests and the coded inference requests the at least one processor causes the transmitter to transmit the inference requests and the coded inference requests over a wireless communication link.

32. The apparatus of claim 31, wherein the apparatus is further caused, by executing the instructions, to implement the encoding by configuring the transmitter to use beamforming on the wireless communication link.

33. The apparatus of claim 30, further comprising a transmitter and wherein to transmit, to the first coded inference stage, the inference requests and the coded inference requests the at least one processor causes the transmitter to transmit the inference requests and the coded inference requests over a wired communication link.

34. The apparatus of claim 30, further comprising a receiver and wherein to receive, from the last coded inference stage, the plurality of inference results and the plurality of estimated inference results the at least one processor causes the receiver to receive the plurality of inference results and the plurality of estimated inference results over a wireless communication link.

35. The apparatus of claim 34, wherein the apparatus is further caused, by executing the instructions, to implement the decoding by configuring the receiver to use beamforming on the wireless communication link.

36. The apparatus of claim 30, further comprising a receiver and wherein to receive, from the last coded inference stage, the plurality of inference results and the plurality of estimated inference results the at least one processor causes the receiver to receive the plurality of inference results and the plurality of estimated inference results over a wired communication link.

37. The apparatus of claim 30, wherein the apparatus is further caused, by executing the instructions, to perform at least one of encoding the inference request by employing a linear code or decoding the plurality of estimated inference results by employing a linear code.

38. The apparatus of claim 30, wherein the apparatus is further caused, by executing the instructions, to receive the plurality of inference requests from a plurality of sources and distribute, among the plurality of sources, respective selected inference results among the plurality of selected inference results.

39. The apparatus of claim 30, wherein the selecting of either the plurality of inference results or the plurality of estimated inference results is based on at least one of a cyclic redundancy check on the plurality of inference results and a cyclic redundancy check on the plurality of estimated inference results or latency conditions being met.

40. A non-transitory computer-readable storage medium comprising instructions for managing a plurality of inference requests indicated associated with a coded inference network representative of a deep neural network (DNN), the coded inference network including a first coded inference stage and a last coded inference stage, the first coded inference stage implementing a first non-linear function representative of a first sub-DNN of the DNN, the last coded inference stage implementing a last non-linear function representative of a last sub-DNN of the DNN, wherein the instructions when executed by at least one computer, cause the at least one computer to:
receive, from a particular source, a particular inference request;
encode the plurality of inference requests, the plurality of inference requests comprising the particular inference request, to form a plurality of coded inference requests, wherein the encoding is specific to the first coded inference stage;
transmit, to the first coded inference stage, the inference requests and the coded inference requests;
receive, from the last coded inference stage, a plurality of inference results and a plurality of redundant inference results;
decode the plurality of inference results and the plurality of estimated inference results to form a plurality of estimated inference results, wherein the decoding is specific to the last coded inference stage;
select either the plurality of inference results or the plurality of estimated inference results, thereby generating a plurality of selected inference results; and
transmit, to the particular source, a particular inference result corresponding to the particular inference request, the particular inference result selected from among the plurality of selected inference results.
